(19) United States
(12) Patent Application Publication
(10) Pub. No.: US 2014/0337402 A1
(43) Pub. Date: Nov. 13, 2014

(54) Analysis Computation Method, Analysis Computation Program and Recording Medium

(71) Applicants: Kazutami Tago, Tokyo (JP); Nobuhiro Kusuno, Tokyo (JP); Kiyomi Yoshinari, Tokyo (JP); Akira Mishima, Tokyo (JP)

(72) Inventors: Kazutami Tago, Tokyo (JP); Nobuhiro Kusuno, Tokyo (JP); Kiyomi Yoshinari, Tokyo (JP); Akira Mishima, Tokyo (JP)

(73) Assignee: Hitachi, Ltd., Chiyoda-ku, Tokyo (JP)

(21) Appl. No.: 14/357,945

(22) PCT Filed: Nov. 14, 2011
(86) PCT No.: PCT/JP2011/076207

§ 371 Date: Jul. 17, 2014

(51) Int. Cl. G06F 17/15

(52) U.S. Cl. CPC G06F 17/153
USPC 708/424

(57) ABSTRACT

A method for efficiently carrying out an analysis and computation using mesh structures is disclosed. When an insulator is brought into contact with two conductors, the mesh structures are generated and a displacement current is analyzed. In the generated structures, the insulator is considered a three-dimensional mesh structure and at least a portion of the conductor brought into contact with the insulator is considered a three-dimensional structure whereas the other portions are taken as a one- or two-dimensional structures. In an alternative, the insulator is considered a three-dimensional structure and at least a portion of the conductor brought into contact with the insulator is considered a three-dimensional structure whereas the other portions are considered three- to one-dimensional structures. In the conductor, a short-circuit section with no mesh elements is provided between at least a portion brought into contact with the insulator and the other portions.

### TECHNICAL FIELD

The present invention relates to technologies for an analysis computation method for carrying out analysis computation by making use of a mesh structure, its analysis computation program and a recording medium.

### BACKGROUND ART

Development of a clean system for solving environmental issues by making use of a motor as a main power source and its apparatus is making progress. An inverter is one of converters in a system used for driving an alternating-current motor. The inverter outputs a rectangular wave voltage generated as a result of switching operations of semiconductor devices. By superposing rectangular waves, a sine wave current having a desired frequency and a desired amplitude can be simulated. Thus, the inverter is a power electronic apparatus which is indispensable to such a system/apparatus.

A rectangular wave includes harmonics which may serve as a source generating electromagnetic noises. In addition, the rectangular wave is conducted through circuits of the apparatus as a surge and affects the voltage endurance characteristics/insulation characteristics of configuration components in some cases. In order to increase the conversion efficiency, on the other hand, the frequency of switching power devices is raised. As the frequency is increased, however, the band of generated noises rises so that the effects on other apparatus are raised with ease. And the rising speed of the surge increases so that the effects on the voltage endurance characteristics/insulation characteristics of configuration components are raised.

Therefore, in product development, countermeasures against noises and surges are taken. In the countermeasure against noises, it is necessary to identify the current path of the noise source in order to suppress the noises. Since noises are generated by charging and discharging which are caused by effects of parasitic elements, however, it is difficult to identify the current path of the noise source from measurements. Thus, an effective countermeasure against noises is to identify the path of a noise current by simulation and set a countermeasure plan. In addition, the other effective countermeasure against a surge is to make use of circuit forms and circuit constants of circuit elements, simulate the waveform of the surge and set a countermeasure plan. Therefore, by carrying out circuit simulation making use of circuit constants of circuit elements including parasitic elements, the characteristics of apparatus noises and surges can be analyzed. In order to carry out such an analysis, however, a preparation to evaluate the constants of the circuits which are parasitic on the structure of the apparatus is required. In addition, the progress in the down-sizing of the apparatus is also progress in shortening of the distance between configuration components. Thus, while the necessity of the countermeasures increases, it is difficult to evaluate parasitic elements in the measurement. If the parasitic elements cannot be evaluated sufficiently, a trial-and-error-based countermeasure needs to be taken.

The wiring in a circuit has a parasitic inductance which affects the conduction of noises and surges. For the difficulty in measuring the parasitic inductance with a sufficient degree of precision, there has already been implemented a program used for carrying out magnetic-field simulation on the wiring shape with a high degree of fidelity and computing the parasitic inductance.

Non-Patent Document 1 describes a technology for implementing such a program. The technology described in Non-Patent Document 1 is a technology related to a voltage source driven current distribution calculation program based on sheet approximation. This program computes a current, an inter-terminal inductance and an inter-terminal resistance with a high degree of efficiency by making use of a 2-dimensional mesh by taking a sheet conductor and the conductor of a skin-effect current as objects of computation in accordance with a finite element method treating a current vector potential as an unknown variable. This program is then applied to the power-electronic device wiring including a board.

In addition, there is Q3D provided by Ansys (a registered trademark) Corporation as an eddy-current analysis program adopting a boundary element method described in Non-Patent Document 2. By making use of a surface mesh of a conductor for an eddy-current analysis, this program is capable of computing a complicated shape by utilization of few meshes. In addition, this program is capable of computing a capacitance by carrying out electrostatic-field computation adopting the boundary element method and capable of computing an electrostatic capacitance with a high degree of efficiency by making use of a surface mesh of a conductor and a 3-dimensional mesh of a dielectric substance.

On the other hand, the mounting wiring including a control board generates noises with frequencies of at least 30 MHz due to a parasitic capacitance. In order to analyze surge and noise characteristics in the apparatus by carrying out circuit simulation making use of the constants of devices including parasitic capacitors, it is necessary to evaluate in advance a capacitance parasitic for the structure of the apparatus. This parasitic capacitance may change the transmission characteristics due to the introduced position of a capacitance in the circuit. It is thus important to correctly evaluate the parasitic capacitance and analyze surge and noise characteristics. Therefore, it is important to carry out electromagnetic-field simulation on the shape/structure of a partial configuration of the entire circuit with a high degree of fidelity and obtain the frequency characteristic of the impedance and distribution-constant parasitic constants. Thus, there is a demand for an electromagnetic-field simulation program introducing a displacement current effect of a parasitic capacitance section, such that it is possible to analyze noises with frequencies of at least 30 MHz with a high degree of fidelity in the apparatus. The capability of computing a complicated shape by making use of few meshes is important from a standpoint of easiness of the mesh creation and standpoints of reduction of the computation time and reduction of a memory in use.

In the modeling of the parasitic capacitance for circuit simulation by taking the frequency dependence characteristic into consideration, however, it is necessary to analyze the frequency dependence including an eddy current and a displacement current. In order to carry out such modeling, in the past, the user made use of an analysis program for high-frequency electromagnetic waves or an analysis program for layer structure inter-plane electromagnetic waves. An example of the analysis program for high-frequency electromagnetic waves is HFSS offered by Ansys (a registered trademark) Corporation. HFSS adopts a 3-dimensional finite element method as described in Non-Patent Document 3. On the other hand, an example of the analysis program for layer structure inter-plane electromagnetic waves is SIwave also offered by Ansys (a registered trademark) Corporation. SIwave adopts a 2-dimensional finite element method as described also in Non-Patent Document 3.

Next, a background technology is explained from a computation-mesh point of view. In the case of a current, unlike a fluid or a thermal flow, the current path is determined by the shape of the conductor when a conductor such as Cu exists which has a conductance value larger than an insulator at least 15 digits, with the conductor allowing a current to flow through Cu with ease. In the low-frequency region for which the skin effect is not effective, an AC current flows through the conductor uniformly and the current path is determined by the shape of the conductor. In the high-frequency region for which the capacitance effect does not exist but the skin effect is effective, on the other hand, an AC current flows through the surface of the conductor and the depth-direction range of the current is determined by the skin effect. It is thus possible to make use of a computation mesh according to the conductor shape in the low-frequency region and a surface 2-dimensional mesh in the high-frequency region. If the capacitance effect exists, an AC current flows through an insulator between surfaces of facing conductors, that is, through a capacitance section. The larger the area of the facing conductors and the shorter the facing distance between the facing conductors, the more effective the capacitance effect and the more easily the displacement current flows in the low-frequency region. At that time, currents in the conductor include not only a current component flowing along the surface of the conductor, but also a current component flowing perpendicularly to the surface of the conductor. Thus, the current which flows when affected by the capacitance effect is 3-dimensional so that it is necessary to carry out computation in 3-dimensional solid meshes.

Q3D of Ansys (a trademark) Corporation mentioned before makes use of a 3-dimensional mesh having a high degree of fidelity for the conductor shape in the analysis of a DC current, makes use of a 2-dimensional surface mesh adopting the boundary element method in the analysis of an AC current and makes use of a 2-dimensional surface mesh in the surface of the conductor. In addition, the electrostatic-field computation adopting the boundary element method of Q3D makes use of a 2-dimensional surface mesh and a 3-dimensional solid mesh, places a 2-dimensional surface mesh on the surface of the conductor and makes use of a 3-dimensional solid mesh in a dielectric substance. This electrostatic-field computation is possible if a dual confliction method described in Non-Patent Document 2 is adopted. A structure created at that time is a structure in which the surface of a solid mesh of the dielectric substance overlaps a surface mesh of the conductor and the solid mesh of the dielectric substance is used in computation of induced charge. In addition, the eddy-current analysis program described in Non-Patent Document 1 mentioned earlier makes use of a surface mesh in the conductor. On the top of that, Non-Patent Document 4 describes a method for computing a conductor current in a 3-dimensional system. In this case, the conductor-current computation described in Non-Patent Document 4 is implemented by making use of a computation mesh having the same dimension.

In order to implement computation of a 3-dimensional system with a high degree of efficiency, it is possible to conceive the use of a low-dimensional mesh for unnecessary locations of the 3-dimensional effect. As such a commonly known example, there is a magnetic eddy-current loss analysis method described in Patent Document 1 as a method for a PM motor. This method makes use of a 2-dimensional magnetic-field computation result in 3-dimensional eddy-current computation of a magnet. The magnetic field is computed in a 2-dimensional system. The obtained magnetic field is taken as a field uniform in an unused dimensional direction and is used in the computation of an eddy current in a 3-dimensional system.

### PRIOR ART DOCUMENTS

### Patent Document

### Patent Document 1

JP-2008-123076-A

### Non-Patent Documents

### Non-Patent Document 1

Hideto Fukumoto: ‘Voltage-driven Current Distribution Analysis by Thin Conductor Approximation’, a paper of a Joint Technical Meeting of the Society of Electrical Engineers in Static Apparatus and Rotating Machinery, SA94-8, RM94-72 (1994)

### Non-Patent Document 2

‘Electrical/Electronic Boundary Element Method’ authored by Yukio Kagawa, Masato Enozono and Tsuyoshi Takeda, Morikita Publishing Company, 2001

### Non-Patent Document 3

‘Electrical-Engineering Finite Element Method’ authored by Takayoshi Nakada and Norio Takahashi, Morikita Publishing Company, 1986

### Non-Patent Document 4

R. Albanese PhD and Prof. G. Rubinacci: ‘Integral formulation for 3D eddy-current computation using edge elements’, P 457-462, IEE Proceedings, Vol. 135, Pt. A, No. 7, September 1988

### SUMMARY OF THE INVENTION

### Problems to be Solved by the Invention

In this case, the program described in Non-Patent Document 1 does not carry out 3-dimensional displacement current computation so that it is difficult to accurately evaluate frequency characteristics including capacitance effects and distribution element constants.

In addition, Q3D provided by Ansys (a registered trademark) Corporation as described in Non-Patent Document 2 does not carry out 3-dimensional displacement current computation so that it is difficult to accurately evaluate frequency characteristics including capacitance effects and distribution element constants.

In addition, HFSS provided by Ansys (a registered trademark) Corporation and described in Non-Patent Document 3 carries out computation by placing a computation mesh in a 3-dimensional space in which an electromagnetic field exists. If the spatial shape is complicated in a big analysis, it is difficult to create a mesh. In computation of an electromagnetic wave, it is not until waves with a plurality of wavelengths exist in the computation system that the precision of the form of the wave is obtained. For example, when analyzing power electronic noises having a frequency of 30 MHz, it is necessary to prepare a 3-dimensional computation system including a space with a size of a further plurality of times a wavelength of 10 m (about 30 times the size of the configuration equipment) and prepare its computation meshes. Thus, the application of the described program is difficult. SIwave offered by Ansys (a trademark) Corporation carries out an analysis in accordance with the finite element method by treating the layer structure conductor inter-plane electromagnetic waves as a 2-dimensional problem. Thus, the object to be analyzed is limited to a layer structure 2-dimensional apparatus such as a board. As a result, the application to a power electronic apparatus such as an inverter having a 3-dimensional wiring shape is difficult.

In general, in comparison with other cases, for a case in which an analysis method for computing a current in a conductor and a displacement current in an insulator, it is nice to prepare a computation system having the configuration equipment size and its computation mesh having a high degree of fidelity for the configuration equipment shape. Thus, the application is considered to be easy. However, even though means for computing only a current in a conductor exists, means for computing both a current in a conductor and a displacement current in an insulator does not exist.

In addition, efficient processing to compute a current in a 3-dimensional complicated shape by making use of few meshes is important for a case in which a capacitance effect is computed. However, so far, means for computing a current including the capacitance effect is not available. Thus, a mesh to be used for efficient computation has not been devised.

In addition, in accordance with the magnetic eddy-current loss analysis method described in Patent Document 1 for a PM (Permanent Magnet) motor, computation of one physical quantity is implemented by making use of meshes having the same dimension. Thus, the method is not a method for computing one physical quantity such as a current by making use of a 3-dimensional mesh and a mesh of low dimensions.

As described above. it is desirable to implement means for computing both a current in a conductor and a displacement current in an insulator. In addition, when preparing a computation system having the configuration equipment size and its computation mesh having a high degree of fidelity for the configuration equipment shape, it is desirable to provide means for reducing the number of dimensions for a computation mesh of a conductor current section with a small effect of a displacement current.

The present invention has been discovered after looking at such a background. That is to say, the present invention solves a problem of how to efficiently carry out the analysis computation making use of a mesh structure.

### Means for Solving the Problems

In order to solve the problem described above, the present invention generates a mesh structure connecting a 3-dimensional mesh structure section to a low-dimensional mesh structure, computes a displacement current in a state in which a 3-dimensional insulator section has been connected to a 3-dimensional conductor section and includes a short-circuit section for eliminating a mesh structure between mesh structure sections.

Other problem solution means is described properly in explanations of embodiments.

### Effects of the Invention

In accordance with the present invention, it is possible to efficiently carry out analysis computation making use of a mesh structure.

### BRIEF DESCRIPTION OF THE DRAWINGS

FIG. 1 is a diagram showing a typical configuration of an analysis computation system according to an embodiment.

FIG. 2 is a diagram showing a typical configuration of a processing section employed in an analysis computation apparatus according to an embodiment.

FIG. 3 is a flowchart showing a procedure of processing carried out by an analysis computation system according to an embodiment.

FIG. 4 is diagrams each showing an example of a computation-system configuration model according to a first embodiment.

FIG. 5 is a diagram showing a state of inter-element connections of connection lines according to the first embodiment.

FIG. 6 is a diagram showing another typical state of inter-element connections of connection lines according to the first embodiment.

FIG. 7 is a diagram showing a state of inter-element connections of connection lines between a 3-dimensional conductor section and a 3-dimensional insulator section in the first embodiment.

FIG. 8 is diagrams each showing a concrete example of a mesh configuration according to the first embodiment.

FIG. 9 is a diagram showing a typical computation-system configuration model according to a commonly known example.

FIG. 10 is a diagram showing elements of a comparison example (Part 1).

FIG. 11 is a diagram showing elements of a comparison example (Part 2).

FIG. 12 is a diagram showing an example of a computation-system configuration model according to a second embodiment.

FIG. 13 is a diagram showing a state of inter-element connections at connection points in the second embodiment.

FIG. 14 is a diagram showing an example of a computation-system configuration model according to a third embodiment.

FIG. 15 is a diagram showing a concrete example of a mesh configuration of a 3-dimensional conductor and a 3-dimensional insulator.

FIG. 16 is a diagram to be referred to in explanation of a typical frequency-characteristic computation result for a mesh structure body.

FIG. 17 is a diagram showing a typical result of eddy-current distribution computation carried out by making use of a mesh structure.

FIG. 18 is a diagram showing an example of a computation-system configuration model according to a fourth embodiment.

FIG. 19 is a diagram showing an inter-element connection state in a short-circuit section according to the fourth embodiment.

FIG. 20 is diagrams each showing a concrete example of a mesh configuration according to the fourth embodiment.

FIG. 21 is a diagram showing a computation result obtained from frequency-characteristic computation carried out by making use of a mesh configuration in the fourth embodiment.

FIG. 22 is a diagram showing an example of a computation-system configuration model according to a fifth embodiment.

FIG. 23 is a diagram showing a state of inter-element connections on a connection face in the fifth embodiment.

FIG. 24 is a diagram showing a concrete example of a mesh configuration in a structure body having a configuration according to the fifth embodiment.

FIG. 25 is a diagram showing typical computation of a frequency characteristic in the fifth embodiment.

FIG. 26 is a diagram showing an example of a computation-system configuration model according to a sixth embodiment.

FIG. 27 is a diagram showing a state of inter-element connections in a short-circuit section according to the fifth embodiment (Part 1).

FIG. 28 is a diagram showing a state of inter-element connections in the short-circuit section according to the fifth embodiment (Part 2).

FIG. 29 is diagrams each showing a concrete example of a mesh configuration according to the sixth embodiment.

FIG. 30 is a diagram showing a result of an analysis and computation which are carried out by making use of mesh configurations created in accordance with the first, fourth and sixth embodiments.

FIG. 31 is a diagram showing an example of a computation-system configuration model according to a seventh embodiment.

FIG. 32 is a diagram showing a state of inter-element connections in a short-circuit section according to the seventh embodiment.

FIG. 33 is a diagram showing a simple system in which a current and a displacement current flow.

### MODE FOR CARRYING OUT THE INVENTION

Next, implementations (each referred to hereafter as an embodiment) of the present invention are explained in detail by properly referring to the diagrams. It is to be noted that, in the diagrams, identical configuration elements are denoted by the same reference numeral and explained only once in order to eliminate duplications of explanations.

Inventors of the present invention have newly established a theory making it possible to compute both a current in a conductor and a displacement current in an insulator. In addition, by making use of the theory, the inventors of the present invention have developed also a method capable of computing both a current in a conductor and a displacement current in an insulator and an apparatus for the method. On the top of that, the inventors of the present invention have developed also an analysis method capable of computing a current by making use of a 3-dimensional mesh and a low-dimension mesh and an apparatus for the analysis method. The methods and the apparatus are explained in detail as follows.

First of all, before a concrete apparatus and the analysis method are explained, the establishment of the new theory making it possible to compute both a current in a conductor and a displacement current in an insulator is described in detail as follows.

As generally known, the Maxwell equations are written as follows.

$$\begin{matrix}[ Expression 1 ] & \\ ∇ \times {E}^{->} = - \frac{\partial {B}^{->}}{\partial t} & ( 1 ) \\ ∇ \times {H}^{->} = {J}^{->} + \frac{\partial {D}^{->}}{\partial t} & ( 2 ) \\ ∇ \cdot {B}^{->} = 0 & ( 3 ) \\ ∇ \cdot {D}^{->} = ρ & ( 4 )\end{matrix}$$

In the above equations, reference symbol E denotes an electric field whereas reference symbol B denotes a magnetic field. Reference symbol H denotes a magnetic flux density whereas reference symbol J denotes a current density. Reference symbol D denotes an electric flux density whereas reference symbol ρ denotes an electric-charge density.

In the Maxwell equations, the electric flux density D, the magnetic field B and the current density J are replaced as follows:

[Expression 2]

\vec{D}=∈\vec{E},\vec{B}=μ\vec{H},\vec{J}=σ\vec{E} (5)

In addition, a magnetic-field vector potential A is expressed by Eq. (6) given below:

[Expression 3]

\vec{B}=∇×\vec{A} (6)

In addition, an electrostatic potential φ is introduced as follows:

$$\begin{matrix}[ Expression 4 ] & \\ ∇ \times ( {E}^{->} + \frac{\partial {A}^{->}}{\partial t} ) = 0 , \\ {E}^{->} + \frac{\partial {A}^{->}}{\partial t} = - ∇ \cdot φ & ( 7 )\end{matrix}$$

Thus, as commonly known, the following equations are derived:

$$\begin{matrix}[ Expression 5 ] & \\ {E}^{->} = - \frac{\partial {A}^{->}}{\partial t} - ∇ φ & ( 8 ) \\ ∇ \cdot ∇ {A}^{->} = μσ ( \frac{\partial {A}^{->}}{\partial t} + ∇ φ ) + ∇ ( ∇ \cdot {A}^{->} ) + μɛ \frac{\partial }{\partial t} ( \frac{\partial {A}^{->}}{\partial t} + ∇ φ ) & ( 9 ) \\ ∇ \cdot ( \frac{\partial {A}^{->}}{\partial t} + ∇ φ ) = - \frac{ρ}{ɛ} & ( 10 )\end{matrix}$$

In the above equations, reference symbol ∈ denotes a dielectric constant whereas reference symbol μ denotes a permeability constant. Reference symbol σ denotes an electric conductivity constant.

In an analysis of a current flowing through a conductor, the electric conductivity constant σ has a value of about 10⁷ A/Vm whereas ∈δ/δt can be ignored even if its value is estimated at a frequency of 1 GHz. This is because the value of ∈ω is expressed by an equation ∈ω=0.0556 A/Vm×the specific dielectric constant. Thus, a term including ∈μ can be omitted. This corresponds to approximation to ignore a phase lag occurring at a propagation time in an electromagnetic wave. Thus a term including ∈μ is omitted. In order to eliminate an indeterminate degree of freedom of the electromagnetic field, a clown gage condition is set as a gage condition as follows.

[Expression 6]

∇·\vec{A}=0 (11)

Thus, Eq. (9) is changed to the following equation:

$$\begin{matrix}[ Expression 7 ] & \\ ∇ \cdot ∇ {A}^{->} = μσ ( \frac{\partial {A}^{->}}{\partial t} + ∇ φ ) = - μ {{J}^{->}}_{E} & ( 12 )\end{matrix}$$

Eq. (12) is an equation related to the conductor current. Thus, in the following description, \vec{J} is expressed by \vec{J}_{E}.

An equation for the displacement current density is given as follows:

$$\begin{matrix}[ Expression 8 ] & \\ {{J}^{->}}_{disp} = \frac{\partial {D}^{->}}{\partial t} = - ɛ \frac{\partial }{\partial t} ( \frac{\partial {A}^{->}}{\partial t} + ∇ φ ) & ( 13 )\end{matrix}$$

Thus, Eq. (10) is an equation related to the displacement current. Numerical computation of the differential equation of Eq. (12) requires a computation mesh in the existence range of magnetic field lines. Normally, such a computation mesh is computed by adoption of the finite element method. If computation meshes are to be created in the existence range of magnetic field lines, however, the number of computation meshes becomes large so that the method is not suitable for numerical computation including displacement-current/impedance-frequency characteristics in the power electronic apparatus.

Thus, Eq. (12) is converted into an integral equation so that the computation mesh existence range can be limited to a range in which a current flows. Since a ferromagnetic substance is generally not used in a power electronic apparatus, a case in which no ferromagnetic substance exists in the analysis range is assumed. At that time, in the high-frequency region, the permeability constant has the same value as a vacuum so that a relative permeability of 1 can be used. In the following description, a uniform permeability constant condition is assumed. Under a condition in which there is no phase lag and the permeability constant is uniform, a formal solution to Eq. (12) is represented as a Biot-Savart theorem like one shown as follows:

$$\begin{matrix}[ Expression 9 ] & \\ {A}^{->} ( {r}^{->} ) = \frac{μ}{4 π} \int \frac{{{J}^{->}}_{E}}{\vert {r}^{->} - {{r}^{->}}^{′} \vert} d {v}^{′} & ( 14 )\end{matrix}$$

If this equation is substituted into following Eq. (15) which is a second equation in Eq. (12), Eq. (16) is obtained.

$$\begin{matrix}[ Expression 10 ] & \\ \begin{matrix}{\vec{J}}_{E} = σ \vec{E} \\ = - σ ( \frac{\partial \vec{A}}{\partial t} + ∇ φ )\end{matrix} & ( 15 ) \\ {\vec{J}}_{E} + σ \frac{μ}{4 π} \int \frac{\dot{{\vec{J}}_{E}}}{\vert \vec{r} - {\vec{r}}^{′} \vert} d {v}^{′} + σ ∇ φ = 0 & ( 16 )\end{matrix}$$

In this case, a time derivative of the current density is expressed as follows:

[Expression 11]

{right arrow over (\dot{J}_{E}≡∂\vec{J}_{E}/∂t (17)

If Eq. (16) is used, as is generally known, with ∇φ taken as a terminal voltage condition term, by placing computation meshes only in the conductor, a current in the conductor can be analyzed. However, an equation related to the conductor current J expressed by Eq. (16) cannot be connected to an equation related to the insulator displacement current expressed by Eq. (10). Thus, in the past, it was impossible to carry out an analysis by adjustment of the displacement current by making use of Eq. (16).

The following description explains derivation of a new equation related to the displacement current to serve as an equation which can be used with the conductor-current integral equation. If the Biot-Savart theorem is adopted, the displacement current density is expressed by the following equation:

$$\begin{matrix}[ Expression 18 ] & \\ {\vec{J}}_{disp} = - ɛ \frac{μ}{4 π} \int \frac{{\ddot{\vec{J}}}_{E}}{\vert \vec{r} - {\vec{r}}^{′} \vert} d {v}^{′} - ɛ ∇ \frac{\partial }{\partial t} φ & ( 18 )\end{matrix}$$

If the frequency components of the first term of Eq. (18) are compared with the frequency components of the second term of Eq. (16), it is obvious that the ratio of the first term of Eq. (18) to the second term of Eq. (16) is ∈ω/σ. As a term including ∈μ has been eliminated from Eq. (9) given earlier, a term including ∈μ can be eliminated also from Eq. (18). This is because the value is small in comparison with the conductor current, being ignorable. Thus, a term taking over the conductor current as a displacement current is the term related to the electrostatic potential of the second term. Accordingly, the displacement current is expressed by the following equation:

$$\begin{matrix}[ Expression 1 ] & \\ {\vec{J}}_{disp} = - ɛ ∇ \frac{\partial }{\partial t} φ & ( 19 )\end{matrix}$$

At that time, even in the case of Eq. (10) which is an equation related to the displacement current, in the same way, the term of the magnetic-field vector potential is ignored to give the following equation:

$$\begin{matrix}[ Expression 14 ] & \\ ∇ \cdot ∇ φ = - \frac{ρ}{ɛ} & ( 20 )\end{matrix}$$

Eq. (20) is a differential equation having an electrostatic potential in the insulation region as an unknown variable. Since a power electronic apparatus may include insulators having different dielectric constants, it is desirable to have a configuration in which the equation related to the displacement current is a differential equation. It is thus desirable to carry out an analysis by treating Eqs. (16) and (20) as simultaneous equations. Since the solution to Eq. (20) is not directly the density of the displacement current, however, the connection with Eq. (16) is difficult. Thus, both Eqs. (16) and (20) are differentiated with respect to time so that the connection can be made possible.

$$\begin{matrix}[ Expression 15 ] & \\ {\dot{\vec{J}}}_{E} + σ \frac{μ}{4 π} \int \frac{{\ddot{\vec{J}}}_{E}}{\vert \vec{r} - {\vec{r}}^{′} \vert} d {v}^{′} + σ ∇ \dot{φ} = 0 & ( 21 ) \\ ∇ \cdot ɛ ∇ \dot{φ} = 0 & ( 22 )\end{matrix}$$

In this case, the electrostatic potential φ is differentiated with respect to time as follows:

[Expression 16]

\dot{φ}≡∂φ/∂t (23)

Since the time differential of the source term of Eq. (22) is a current flowing to and from the boundary between the conductor and the insulator, it is considered as a current continuity condition in the following description.

[Expression 17]

(\vec{J}_{E}+∈∇\dot{φ})·\vec{n}|ₛ=0 (24)

Eqs. (21), (22) and (24) have a form in which \vec{J}_{E} and −∈∇\dot{φ} are spatially connected to each other on the boundary between the conductor and the insulator so that they can be spatially solved.

As described below, in order to make computation performed by a first analysis computation apparatus possible, discretization adopting the finite element method is carried out. In this case, FIG. 33 shows a simple system in which a current and a displacement current flow. As shown in FIG. 33, the system is assumed to have a configuration connected to an external circuit by a current i and, in the configuration, a potential appearing at an electrode varies with the lapse of time.

If Eqs. (22), (23) and (24) are written by adoption of the Galerkin method, the following equation is obtained.

$$\begin{matrix}[ Expression 18 ] & \\ {\int }_{{Ω}_{M}} {\vec{J}}_{E} \cdot \{ \frac{μ}{4 π} {\int }_{{Ω}_{M}} \frac{{\ddot{\vec{J}}}_{E} ( {\vec{r}}^{′} )}{\vert \vec{r} - {\vec{r}}^{′} \vert} d {v}^{′} + \frac{1}{σ} {\dot{\vec{J}}}_{E} + ∇ \dot{φ} \} d v + {\int }_{{Ω}_{D}} \dot{φ} \{ ∇ \cdot ( ɛ ∇ \dot{φ} ) \} d v = 0 & ( 25 )\end{matrix}$$

In the above equation, reference symbol Ω_{M} denotes a conductor whereas reference symbol Ω_{D} denotes an insulator.

If partial integration is applied to the last term of Eq. (25) whereas a terminal portion and the boundary between the conductor and the insulator are expressed by separating them from each other, the following equation is obtained.

$$\begin{matrix} [ Expression 19 ] & \\ \frac{μ}{4 π} {\int }_{{Ω}_{M}}^{ } {\int }_{{Ω}_{M}}^{ } \frac{{\vec{J}}_{E} ( \vec{r} ) \cdot {\ddot{\vec{J}}}_{E} ( {\vec{r}}^{′} )}{\vert \vec{r} - {\vec{r}}^{′} \vert} d {v}^{′} d v + {\int }_{{Ω}_{M}} \frac{{\vec{J}}_{E} \cdot {\dot{\vec{J}}}_{E}}{σ} d v + {\sum }_{i}^{ } {J}_{i} \cdot {\dot{φ}}^{out} ( i ) + {\int }_{{Ω}_{M} surf ( D )} \dot{φ} {\vec{J}}_{E} \cdot \vec{n} d S + {\int }_{{Ω}_{Dsurf}} \dot{φ} ɛ ∇ \dot{φ} \cdot \vec{n} d S - {\int }_{{Ω}_{D}} {ɛ ( ∇ \dot{φ} )}^{2} d v = 0 & ( 26 )\end{matrix}$$

In the above equation, reference symbol Ω_{M}surf (D) denotes the conductor-insulator boundary seen from the conductor side whereas reference symbol Ω_{D}surf denotes the conductor-insulator boundary seen from the insulator side. The fourth term of Eq. (26) is a conductor-side boundary condition on the boundary between the conductor and the insulator whereas the fifth term of Eq. (26) is an insulator-side boundary condition on the boundary between the conductor and the insulator. On the boundary between the conductor and the insulator, they have the same value. Thus, in the following description, an equation of the fourth term is used.

If Eq. (26) is rewritten by dividing the expression into a conductor-current portion and a displacement-current portion and dividing the integration into integrations for each of meshes, the following equations are obtained:

$$\begin{matrix} [ Expression 20 ] & \\ \frac{μ}{4 π} {\sum }_{m}^{ } {\sum }_{{m}^{′}}^{ } {\int }_{{Ω}_{M}^{m}} {\int }_{{Ω}_{M}^{{m}^{′}}} \frac{{{\vec{J}}_{E} ( \vec{r} , t )}_{m} \cdot {{\ddot{\vec{J}}}_{E} ( {\vec{r}}^{′} , t )}_{{m}^{′}}}{\vert \vec{r} - {\vec{r}}^{′} \vert} d {v}^{′} d v + {\sum }_{m}^{ } \frac{1}{{σ}_{m}} {\int }_{{Ω}_{M}^{m}} ( {\vec{J}}_{{E}_{m}} ( \vec{r} , t ) \cdot {\dot{\vec{J}}}_{{E}_{m}} ( \vec{r} , t ) ) d v + {\sum }_{s}^{ } {\int }_{{Ω}_{Msurf}^{s} ( D )} {\dot{φ}}_{s} ( \vec{r} , t ) {\vec{J}}_{{E}_{s}} ( \vec{r} , t ) \cdot \vec{n} d S + {\sum }_{i}^{ } {J}_{i} \cdot {\dot{φ}}^{out} ( i ) = 0 & ( 27 ) \\ - {\sum }_{m}^{ } {ɛ}_{m} {\int }_{{Ω}_{D}^{m}} ( ∇ {\dot{φ}}_{m} ( \vec{r} , t ) \cdot ∇ {\dot{φ}}_{m} ( \vec{r} , t ) ) d v + {\sum }_{s}^{ } {\int }_{{Ω}_{Msurf ( D )}^{s}} {\dot{φ}}_{s} ( \vec{r} , t ) {\vec{J}}_{{E}_{s}} ( \vec{r} , t ) \cdot \vec{n} d S = 0 & ( 28 )\end{matrix}$$

In the above equations, notations m and m′ are each a mesh number whereas notation s is the number of a mesh connected to the boundary between the conductor and the insulator. Notation i is the number of a terminal.

It is natural to select a current vector potential \vec{T} based on a current vector potential according to Eq. (29) given below as an unknown variable of Eq. (27) and select a displacement-current scalar potential \dot{φ} according to Eq. (30) given below as an unknown variable of Eq. (28).

[Expression 21]

\vec{J}_{E}=∇×\vec{T} (29)

\vec{J}_{disp}=−∈∇\dot{φ} (30)

Thus, it is possible to carry out numerical computations making use of a finite element method with edge elements and a finite element method with nodal elements respectively. In the finite element method with edge elements, if the conductor-current density \vec{J}_{E}(\vec{r},t)ₘ in the mth mesh is described in terms of an unknown variable Tⱼ(t) on the jth side of the mesh and an interpolation function \vec{N}ⱼ(\vec{r}) the following expression is obtained:

$$\begin{matrix}[ Expression 22 ] & \\ {{\vec{J}}_{E} ( \vec{r} , t )}_{m} = {\{ {\sum }_{j}^{ } \{ ∇ \times {\vec{N}}_{j} ( \vec{r} ) \} \cdot {T}_{j} ( t ) \}}_{m} & ( 31 )\end{matrix}$$

By the same token, in the node-point finite element method, if the displacement-current density \vec{J}_{disp}(\vec{r},t)ₘ in the mth mesh is described by in terms of unknown variable φk(t) on the kth side of the mesh and an interpolation function \dot{φ}ₖ(t), the following expression is obtained:

$$\begin{matrix}[ Expression 23 ] & \\ {{\vec{J}}_{disp} ( \vec{r} , t )}_{m} = {\{ {\sum }_{k}^{ } {ɛ}_{k} \cdot \{ ∇ {N}_{k} ( \vec{r} ) \} {\dot{φ}}_{k} ( t ) \}}_{m} & ( 32 )\end{matrix}$$

From Eq. (31), if spatial integration for the interpolation function of Eq. (27) is implemented, Eq. (27) becomes Eq. (33) given below. Eq. (33) is a matrix equation taking Tⱼ (t) on a side as an unknown variable.

By the same token, Eq. (28) becomes Eq. (34) given below. Eq. (34) is a matrix equation taking \dot{φ}ₖ(t) at a node point as an unknown variable.

$$\begin{matrix} [ Expression 24 ] & \\ {\sum }_{j}^{ } {\sum }_{{j}^{′}}^{ } {T}_{j} \cdot {\ddot{T}}_{{j}^{′}} {M}_{j , {j}^{′}} + {\sum }_{j}^{ } {\sum }_{{j}^{′}}^{ } {T}_{j} \cdot {\dot{T}}_{{j}^{′}} {R}_{j , {j}^{′}} + {\sum }_{k}^{ } {\sum }_{{j}^{′}}^{ } {\dot{φ}}_{k} \cdot {T}_{{j}^{′}} {C}_{{s}_{k , {j}^{′}}} + {\sum }_{j}^{ } {T}_{j} \cdot {F}_{j} = 0 & ( 33 ) \\ - {\sum }_{k}^{ } {\sum }_{{k}^{′}}^{ } {\dot{φ}}_{k} \cdot {\dot{φ}}_{{k}^{′}} {C}_{k , {k}^{′}} + {\sum }_{k}^{ } {\sum }_{{j}^{′}}^{ } {\dot{φ}}_{k} \cdot {T}_{{j}^{′}} {C}_{{s}_{k , {j}^{′}}} = 0 & ( 34 )\end{matrix}$$

Matrix components of Eqs. (33) and (34) are computed by making use of equations given as follows:

$$\begin{matrix} [ Expression 25 ] & \\ {M}_{j , {j}^{′}} = \frac{μ}{4 π} {\sum }_{m ( {Ω}_{M}^{m} ∈ j )}^{ } {\sum }_{{m}^{′} ( {Ω}_{M}^{{m}^{′}} ∈ {j}^{′} )}^{ } {\int }_{{Ω}_{M}^{m}} {\int }_{{Ω}_{M}^{{m}^{′}}} \frac{\{ ∇ \times {\vec{N}}_{j} ( \vec{r} ) \} \cdot \{ ∇ \times {\vec{N}}_{{j}^{′}} ( {\vec{r}}^{′} ) \}}{\vert \vec{r} - {\vec{r}}^{′} \vert} d {v}^{′} d v & ( 35 ) \\ {R}_{j , {j}^{′}} = {\sum }_{m ( {Ω}_{M}^{m} ∈ j or {j}^{′} )}^{ } \frac{1}{{σ}_{m}} {\int }_{{Ω}_{M}^{m}} \{ ∇ \times {\vec{N}}_{j} ( \vec{r} ) \} \cdot \{ ∇ \times {\vec{N}}_{{j}^{′}} ( \vec{r} ) \} d v & ( 36 ) \\ {C}_{{s}_{k , {j}^{′}}} = {\sum }_{s ( {Ω}_{Msurf ( D )}^{s} ∈ k or {j}^{′} ) {Ω}_{Msurf ( D )}^{s}}^{ } \int {N}_{k} ( \vec{r} ) \{ ∇ \times {\vec{N}}_{{j}^{′}} ( \vec{r} ) \} \cdot \vec{n} d S & ( 37 ) \\ {C}_{k , {k}^{′}} = {\sum }_{m ( {Ω}_{D}^{m} ∈ k or {k}^{′} )}^{ } {ɛ}_{m} {\int }_{{Ω}_{D}^{m}} \{ ∇ {N}_{k} ( \vec{r} ) \} \cdot \{ ∇ {N}_{{k}^{′}} ( \vec{r} ) \} d v & ( 38 )\end{matrix}$$

Integration computations of Eqs. (35) to (38) are integrations making use of interpolation functions of elements and represent coefficient matrix components of finite element discretization.

In the above equations, reference symbol M denotes an impedance matrix, reference symbol R denotes a resistance matrix, reference symbol Cₛ denotes a matrix of connections of currents and displacement currents, reference symbol C denotes a matrix of coefficients of the Poisson equation and reference symbol F denotes a power-supply term vector.

In this case, the power-supply term vector F is expressed by Eq. (39) given below. In this equation, reference symbol vᵢ denotes a voltage appearing at a terminal i, reference symbol \vec{V} denotes {vᵢ}, that is, \vec{V}={vᵢ} and reference symbol W denotes a matrix of development to unknown variables of terminal potentials.

[Expression 26]

F=W{dot over (\vec{V} (39)

In the case of a current vector potential of Eq. (33), if T on a side of a computation mesh is all used, indeterminateness is included. Thus, as described in Non-Patent Document 4, a commonly known tree/co-tree gage condition is used in order to get rid of the indeterminateness. In addition, if a boundary condition of a certain terminal is thought of, a current I passes through the terminal at a magnitude expressed by the following equation:

$$\begin{matrix}[ Expression 27 ] & \\ \begin{matrix}I = \int ∇ \times \vec{T} \cdot d \vec{S} \\ = ∮ \vec{T} \cdot d \vec{S} \\ = {\sum }_{i ⋐ l}^{ } {c}_{i} {T}_{i} , {c}_{i} \\ = 1 or - 1\end{matrix} & ( 40 )\end{matrix}$$

This implies that, for the boundary condition, a dependent component of the current vector potential is included. In addition, on the surface of the conductor, the in and out flow of a current on the surface side of each mesh on the surface is 0. Thus, for each mesh, a I=0 condition holds true in Eq. (40) and a dependent component of the current vector potential appears for each mesh. Therefore, the coefficient matrix is converted by making use of Eq. (40) which is a boundary condition relation equation so that only independent components can be computed.

As described above, it is possible to obtain equations which take the vector T of the edge current vector potential having an independent component and the vector \dot{φ} of the displacement-current scalar potential at nodal points as unknown variables. Their matrix equations have the following forms:

[Expression 28]

T^{t}(M\ddot{T}+R\dot{T}+C_{T}^{t}\dot{φ}+F)=0 (41)

\dot{φ}^{t}(−C\dot{φ}+CₛT_{b})=0 (42)

In the above equations, reference symbol F denotes a terminal voltage term vector whereas reference symbol T_{b} denotes a vector of a edge current vector potential on the boundary between the conductor and the insulator. In addition, reference symbol C_{T} denotes a matrix of the \dot{φ} vector length×the T vector length. The matrix C_{T} is a transpose matrix in which the Cₛ column is placed only on a column corresponding to the T_{b} component. Thus, other components are 0. By applying the residual method, the following matrix equations are obtained.

[Expression 29]

M\ddot{T}+R\dot{T}+C_{T}^{t}\dot{φ}+F=0 (43)

−C\dot{φ}+CₛT_{b}=0 (44)

Eq. (44) can be solved by adopting a matrix solving technique such as the ordinary direct method. The vector of the displacement-current scalar potential at nodal points can be described as follows:

[Expression 30]

\dot{φ}=C⁻¹CₛT_{b}=C⁻¹C_{T}T (45)

As described above, the displacement-current solution can be represented by a current vector potential. If Eq. (45) is substituted into Eq. (43), it is possible to obtain a second-order differential matrix equation for time in which only the vector T of the edge current vector potential like the one mentioned before is taken as an unknown variable.

[Expression 31]

M\ddot{T}+R\dot{T}+C_{T}^{t}C⁻¹C_{T}T+F=0 (46)

Eq. (46) has a form similar to an LRC circuit equation given below. This equation can be used to obtain a current distribution.

$$\begin{matrix}[ Expression 32 ] & \\ L \cdot \ddot{I} + R \cdot \dot{I} + \frac{1}{C} \cdot I \cdot {\dot{V}}_{out} = 0 & ( 47 )\end{matrix}$$

In the above equations, a matrix M is an inductance matrix whereas reference symbol R denotes a resistance matrix. Reference symbol C_{T}^{t}C⁻¹C_{T} denotes an elastance matrix. The reciprocal of the elastance is the capacitance. By setting the matrixes M, R and C_{T}^{t}C⁻¹C_{T} as well as the vector F, Eq. (46) can be solved for T. As for the frequency dependence characteristic (or the frequency characteristic), Eq. (46) can be used in an analysis by converting Eq. (46) into the following frequency equation.

[Expression 33]

−ω²MT+jωRT+C_{T}^{t}C⁻¹C^{T}+jωW\vec{V}=0 (48)

In the above equation, reference symbol co denotes an angular frequency whereas prefix j denotes a pure imaginary unit. Eq. (48) is a complex-number matrix equation which can be solved by adoption of the matrix solution method such as the direct method in order to compute a current distribution at every frequency.

From each terminal current and each terminal voltage which have been obtained by carrying out theses AC analyses, an AC impedance can be found by performing processing as follows.

A voltage appearing at each terminal i is vᵢ which can be expressed as follows: \vec{V}={vᵢ}. If there are only 2 terminals, the impedance Z between these terminals is related to a difference (vᵢ−vⱼ) in potential between the terminals and a current Iᵢⱼ flowing through the terminals as follows:

vᵢ−vⱼ=Z×Iᵢⱼ (49)

Thus, the following computation can be carried out.

Z=(vᵢ±vⱼ)/Iᵢⱼ (50)

If there are many terminals, on the other hand, matrix computation is required as described below.

Let reference symbol W denote a matrix of expansion to unknown variables which are each a terminal potential. In this case, currents \vec{I}={Iᵢ} at the terminals can be expressed as follows:

[Expression 34]

\vec{I}=W^{t}T (51)

In addition, by writing Eq. (48) in a form like Eq. (52) and introducing a coefficient matrix A, Eq. (53) is obtained.

[Expression 35]

AT+jωW\vec{V}=0 (52)

T=−jωA⁻¹W\vec{V} (53)

Thus, an equation like one shown below can be written.

[Expression 36]

\vec{I}=−jωW^{t}A⁻¹W\vec{V} (54)

Let reference symbol Y denote an admittance matrix between terminals. In this case, by making use of Eq. (55), the admittance matrix Y can be expressed by Eq. (56) as follows.

[Expression 37]

\vec{I}=Y\vec{V} (55)

Y=−jωW^{t}A⁻¹W (56)

In this case, the terminal voltage is meaningful when a voltage relative to a reference electrode is considered. Thus, when computing an impedance, it is necessary to determine the reference electrode such as an earth electrode and carry out computation of a matrix excluding the component of the reference electrode. The impedance of a strip line can be computed as an inverse matrix of a matrix \tilde{Y} excluding the component of the reference electrode.

[Expression 38]

Z=\tilde{Y}⁻¹, \vec{V}−\vec{V_{G}}=Z{tilde over (\vec{I}, \vec{V_{G}}={ν_{G}} (57)

In the above equation, reference symbol ν_{G} denotes the potential of the reference electrode.

The description given above shows that the current displacement current of the wiring insulator can be computed and a current distribution as well as an impedance characteristic can be theoretically computed. Thus, from a frequency-versus-impedance curve, an equivalent-circuit distribution constant can be extracted by adoption of a fitting technique. In addition, the matrixes M, R and C_{T}^{t}C⁻¹C_{T} of Eq. (46) can be condensed between terminals by making use of W in order to compute the inter-terminal inductance Lij, the inter-terminal resistance Rij and the elastance C⁻¹ij.

The following description explains a method for computing magnetic and electric fields from the obtained current and the obtained displacement current. If a spatial distribution of the conductor current at certain frequencies can be obtained on the basis of Eq. (29) by solving Eq. (48), by making use of Eq. (14) which is the Biot-Savart theorem, the magnetic-field vector potential can be computed and, by making use of Eq. (6), a magnetic-field distribution at its frequencies can be computed.

In addition, if a spatial distribution of \dot{φ} at certain frequencies is obtained by making use of Eq. (45), an electric-field distribution at its frequencies can be computed by making use of the following equation:

[Expression 39]

jω\vec{E}=−∇\dot{φ} (58)

Thus, from the frequency characteristic of the current distribution, radiated noises can be evaluated.

With regard to the computation mesh, as described above, when the conductor is not affected by the capacitance effect, in a low-frequency region, a computation mesh according to the shape of the conductor is used. In a high-frequency region, on the other hand, a surface 2-dimensional mesh is used. When the conductor is affected by the capacitance effect, on the other hand, the current is 3 dimensional so that computation by 3-dimensional solid meshes is required. According to the derivation theory explained earlier, in a computation mesh of a conductor region, on a conductor-insulator boundary through which a displacement current flows, a 3-dimensional mesh of the insulator region is connected to a 3-dimensional mesh of the conductor region. In addition, on a conductor-insulator boundary regarded as a boundary through which no displacement current flows, the insulator is eliminated to provide a conductor surface which a current does not flow in and flow out. Thus, there may be a conductor-region 3-dimensional mesh not connected to an insulator-region 3-dimensional mesh. This means that it is not necessary to place an insulator-region 3-dimensional mesh on the surface of the conductor. Thus, this feature is advantageous to efficient implementation of computation of the flow of a current in a 3-dimensional system.

In addition, a power electronic apparatus may include a portion which can be analyzed as a low-dimensional conductor in cases including a case in which the effect of the displacement current is small and the skin portion is handled 2-dimensionally, a case in which the conductor is handled 2-dimensionally as a thin plate and a case in which the conductor is treated 1-dimensionally as a wire. In such portions, a 2-dimensional or 1-dimensional computation mesh is used and computation of such portions along with 3-dimensional computation of a displacement-current portion is conceivable. It is desirable because, in that case, also for the 2-dimensional and 1-dimensional computations, the equations have the same form as Eqs. (46) and (48) and batch computation adopting the matrix solution method can be carried out. In the derivation theory described before derivation of equations in a 3-dimensional system is shown. With regard to only a conductor current, however, 2-dimensional and 1-dimensional formulations can be implemented.

In this case, if the current vector potential is treated as an unknown variable, Eqs. (46) and (48) can be expressed as a matrix equation having a form excluding the capacitance term C_{T}^{t}C⁻¹C_{T}T in 2 and 1 dimensions. Thus, 3-dimensional, 2-dimensional and 1-dimensional matrix equations can be combined into the forms of Eqs. (46) and (48) in order to carry out computations as one matrix equation.

Thus, the number of computation meshes can be reduced to analyze a 3-dimensional phenomenon of a current displacement current of a wiring insulator with a high degree of efficiency.

When this computation is implemented, it is necessary to establish electrical connections to a 3-dimensional mesh edge surface and a 2-dimensional mesh edge surface or a 1-dimensional mesh edge point. This connection has the same meaning as a case in which the edges of these meshes have been connected to a terminal, setting a boundary condition of the current vector potential. Let reference symbols Ta, Tb, Tc and so on each denote one of current vector potentials composing a terminal. In this case, an equation expressing the current vector potentials Ta, Tb, Tc and so on can be written in the same way as Eq. (40) as follows:

$$\begin{matrix}[ Expression 40 ] & \\ [ ( row vector comprised of - 1 , 0 , - 1 ) ] [ \begin{matrix}{T}_{a} \\ {T}_{b} \\ {T}_{c} \\ ⋮\end{matrix} ] & ( 59 )\end{matrix}$$

At that time, since the current vector potential includes a dependent component, the coefficient matrix of Eq. (33) is converted by making use of Eq. (59) serving as a boundary condition so that only an independent component can be computed. An equation obtained as a result of the conversion is newly deformed into the form of Eqs. (46) and (48) and, if Eq. (48) can be solved, the current and the displacement current can be computed. The connection to the terminal is possible as condition setting even if the meshes are not linked. Thus, the derivation theory described before can be adopted also when omitting a fine structure in which the distances between meshes are sufficiently short and effects on inductances as well as resistances can be ignored.

It is to be noted that a terminal having a voltage condition is a part of which connection to the conductor is assumed and is not a conductor surface. In addition, a terminal at a connection to a 3-dimensional mesh described earlier or a low-dimensional mesh described earlier is normally an internal terminal. However, such a terminal can also be used as an external terminal having a connection with an external portion. In this case, the equation of current vector potentials composing the terminal is obtained by making use of the right-hand side of Eq. (59) as an external terminal current I.

In addition, Eqs. (40) and (59) prescribe electrical connection relations between element faces, edge lines and edge points composing a terminal. Thus, it is not always necessary that the relations are connection relations sharing a node point having the same number. However, even though the positional relation is not prescribed, in spite of existence in an electrical connection relation, if the position is separated away, the computation errors of Eqs. (35) to (38) increase so that correct computation cannot be carried out. Thus, to put it correctly, element faces, terminal lines and terminal points composing a terminal by electrical connections between conductors need to mutually exist in an error range of the analysis computation apparatus 1. This is referred to as a state in which the element faces, the terminal lines and the terminal points have been connected or linked.

Next, the following description explains a method for applying the theory described above to actual analysis computations.

### (System Configuration Example)

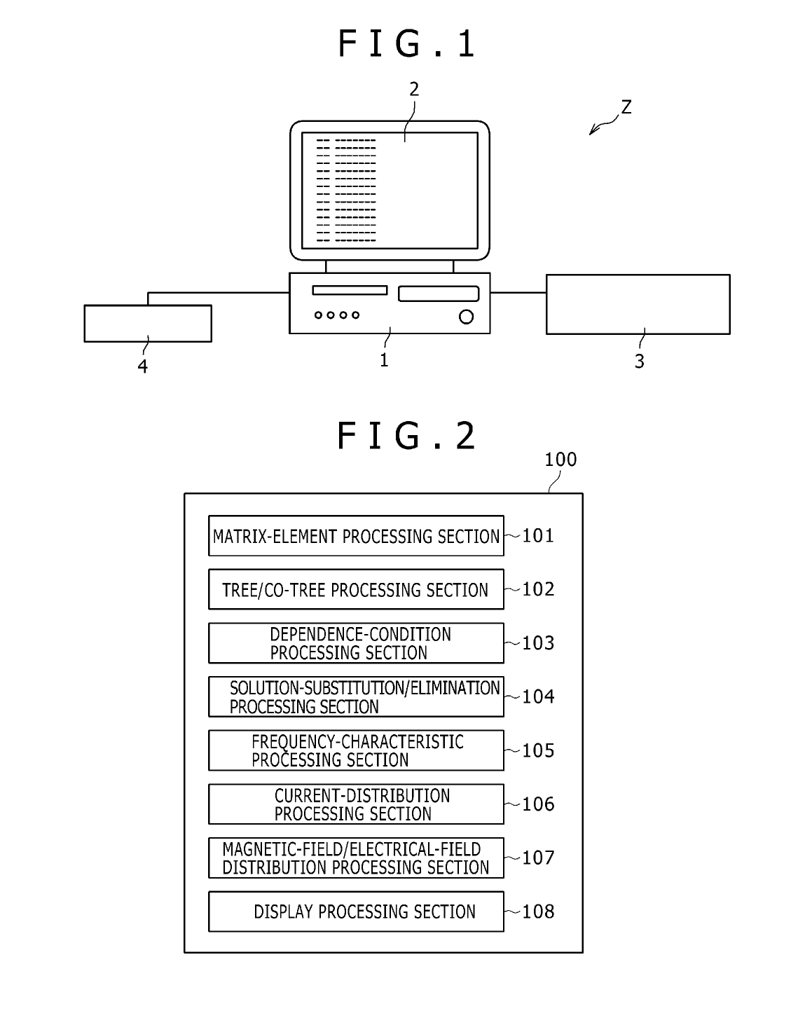

FIG. 1 is a diagram showing a typical configuration of an analysis computation system according to an embodiment.

The analysis computation system Z has an analysis computation apparatus 1, a display apparatus 2, an input apparatus 3 and a storage apparatus 4. The analysis computation apparatus 1 is provided with a central processing apparatus such as a CPU (Central Processing Unit) and has an internal storage apparatus such as a cache memory. The display apparatus 2 comprises an image processing apparatus and a display screen such as a liquid-crystal screen. The input apparatus 3 comprise a direct input apparatus which include a keyboard and a mouse as well as a medium input apparatus. The storage apparatus 4 is a storage medium which is a generic name for a semiconductor storage medium and a disk medium such as a hard disk.

FIG. 2 is a diagram showing a typical configuration of a processing section employed in the analysis computation apparatus according to an embodiment.

The processing section 100 has a matrix-element processing section 101, a tree/co-tree processing section 102, a dependence-condition processing section 103, a solution-substitution/elimination processing section 104, a frequency-characteristic processing section 105, a current-distribution processing section 106, a magnetic-field/electrical-field distribution processing section 107 and a display processing section 108.

The matrix-element processing section 101 generates 3-dimensional, 2-dimensional and 1-dimensional meshes on an object of computation and, if necessary, links them together.

The tree/co-tree processing section 102 carries out tree/co-tree processing to be described later.

The dependence-condition processing section 103 carries out dependence condition generation processing to be described later.

The solution-substitution/elimination processing section 104 carries out solution substitution/elimination processing to be described later.

The frequency-characteristic processing section 105 computes a frequency characteristic which is a dependence relation between the impedance and the frequency.

The current-distribution processing section 106 computes a current distribution in an object of computation.

The magnetic-field/electrical-field distribution processing section 107 computes a magnetic-field distribution and an electric-field distribution in an object of computation.

The display processing section 108 displays results of processing carried out by sections such as the frequency-characteristic processing section 105, the current-distribution processing section 106 and the magnetic-field/electrical-field distribution processing section 107 on the display apparatus 2.

The processing section 100 and the sections 101 to 108 are realized by a CPU executing an analysis computation program loaded into a RAM (Random Access Memory) from a ROM (Read Only Memory) or a hard disk. It is to be noted that the analysis computation program has been recorded in the so-called recording medium which can be read by a computer. The recording medium includes a magnetic recording medium such as a hard disk and an optical recording medium such as a CD-ROM (Compact Disk-Read Only Memory) or a DVD-ROM (Digital Versatile Disk-Read Only Memory).

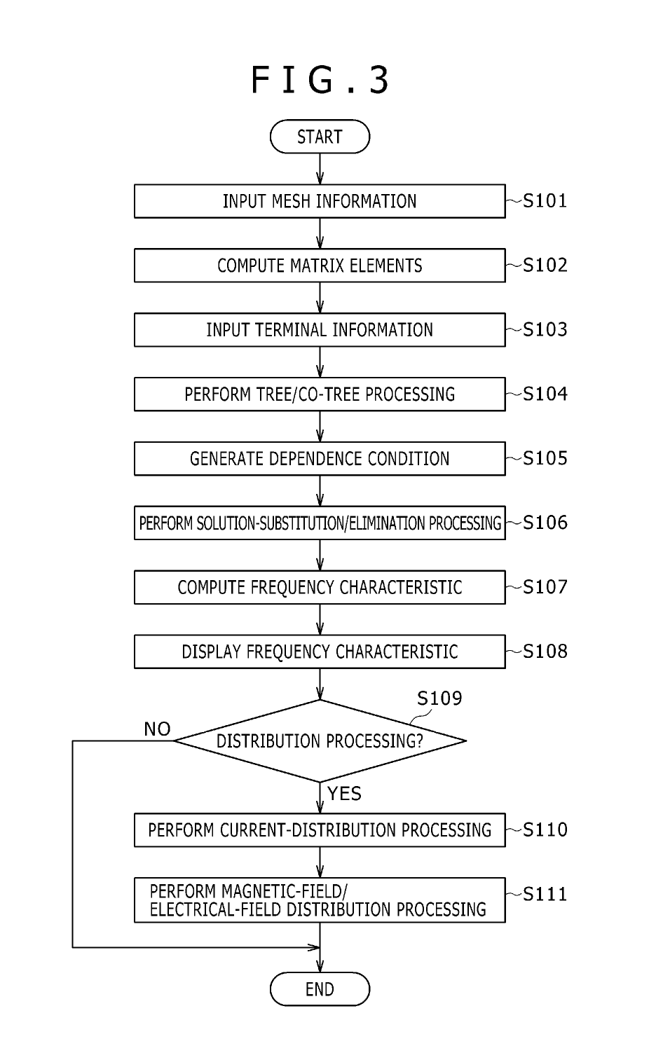

FIG. 3 is a flowchart showing a procedure of processing carried out by the analysis computation system according to an embodiment. FIGS. 1 and 2 are properly referred to.

First of all, at a step S101, the analysis computation apparatus 1 receives a mesh information input from a mesh creation apparatus (not shown) different from the analysis computation apparatus 1 and generates a mesh on an object of an analysis. The mesh information may also be received from an apparatus other than the mesh creation apparatus. In the case of a 3-dimensional finite element method mesh, the mesh information includes the number of finite elements composing a mesh, the number of nodal points, 3-dimensional coordinates for each of the nodal points, the number of each of the elements, the number of a nodal point of each of the elements and the type of each of the elements. Explanation of element types is described later. In addition, in each of the elements composing the mesh, elements of the same element type share order of the nodal points, element-surfaces, and element-edges of an element, and direction of edge vector of an element. In addition, the mesh information also includes physical-property quantities linked to the number of each element, such as a material quality number indicating the conductor of each element or the insulator of each element and the electrical conductivity constant or the dielectric constant. It is desirable to have a configuration in which the material quality numbers in the same and contiguous physical matters having the same physical-property quantity are the same material quality number. The element type may indicate the type of an element for each dimension. In the case of a 3-dimensional element, the element type is a tetrahedron, a prism and a hexahedron. In the case of a 2-dimensional element, the element type is a triangle and a rectangle. In the case of a 1-dimensional element, the element type is a line segment. In the case of a 2-dimensional element, the mesh information may include the thickness associated with the number of the element for each element. In the case of a 1-dimensional element, the mesh information may include the line thickness associated with the number of the element for each element. That is to say, area information may be included.

In the case of a 3-dimensional element, whether or not 2 elements are adjacent elements sharing a certain face is determined by determining whether or not node points of the element faces are shared. Thus, followings are provided as information on the adjacency relation between elements: the number of adjacent conductor elements, the face number of own element, and the number of the adjacent element; the number of adjacent insulator elements, the face number of own element, and the number of the adjacent element; and the number of element faces each serving as a surface and the number of each element own face. In this way, information is given to indicate whether the element is an element inside a mesh, an element on a surface or an element on the boundary between a conductor and an insulator. In the case of a 2-dimensional element, the adjacency relation is determined by determining whether or not node points on element edges are shared. By treating an element face as an element edge line, adjacency relation information can be given. In the case of a 1-dimensional element, the adjacency relation is determined by determining whether or not a node point on an element edge is shared. By treating an element face as an element node point, adjacency relation information can be given. In addition, a current vector potential of a 3-dimensional element is set on a edge of the element. Thus, the matrix-element processing section 101 computes the total number of edges composing the element, generates sequence numbers for each edge and creates a list assigning the sequence numbers in a edge-number order for each element. Since the direction of a positive current vector potential on a sequence side is determined, the matrix-element processing section 101 generates and stores the following edge information in each element. The edge information is “−1” if the positive direction is opposite to the direction of a edge of the element. If the positive direction is the same direction as a edge of the element, on the other hand, the edge information is “1”.

In this way, at the step S101, the matrix-element processing section 101 generates a mesh on the object of computation.

It is to be noted that, as described before, the mesh information at the step S101 can also be generated by a mesh creation apparatus different from the analysis computation apparatus 1 shown in FIG. 1. However, the mesh information can also be generated by another apparatus. In addition, the mesh information can also be supplied by the user through the input apparatus 3. On the top of that, after the mesh information has been generated for meshes of all dimensions, the mesh information is generated again by rearranging element numbers so that the node-point numbers agree with the element numbers. It is to be noted that, after the mesh information has been generated, the appearance of the mesh may also be displayed on the display apparatus 2. In addition, element constant inductances between terminals, resistances between the terminals and elastances between the terminals can also be computed by reducing coefficient matrixes of Eq. (48) to those between the terminals.

Then, at a step S102, by making use of a edge element interpolation function \vec{N}ⱼ(\vec{r}) and a nodal point interpolation function Nₖ(\vec{r}) for each element and on the basis of the mesh information obtained at the mesh input step S101, the matrix-element processing section 101 carries out matrix element computation of computing Eqs. (35) to (38). The integration computation carried out at that time is numerical integration like one adopting the Gauss integration method. In addition, for an element on which analysis integration can be carried out as is the case with a triangular element and a tetrahedron element, the analysis integration can also be used. In this case, a triangular element means a mesh element having a triangular shape whereas a tetrahedron element means a mesh element having a the shape a triangular pyramid.

Then, at a step S103, terminal information is received from the input apparatus 3. The terminal information is information on terminals of the object of an analysis. If the mesh structure body obtained by converting the object of an analysis into a mesh comprises 3-dimensional elements, the terminal information includes the number of terminals, terminal numbers, terminal-type information, the numbers of elements composing each of the terminals and element face numbers. If the mesh structure body comprises 2-dimensional elements, the element face number becomes an element edge line number. Other terminal information is the same as that of a 3-dimensional element. If the mesh structure body comprises 1-dimensional elements, the element face number becomes an element edge point number. Other terminal information is the same as that of a 3-dimensional element.

The terminal-type information is information on the type of a terminal. For example, the terminal-type information of “1” indicates that the terminal is a terminal connected to an external component. In this case, Eq. (40) is used as the magnitude of a current I flowing through such a terminal. A current flowing-out/in condition number of 0 indicates that the terminal is a terminal connected to an internal component. In this case, the magnitude of a current I flowing from such a terminal to an external system is 0 and Eq. (59) is used.

Then, at a step S103, terminal information is set. The set terminal information is terminal information on, among others, electrical connection relations of each element face, each edge line and each edge point which compose terminals. Terminals do not have to share the same node point even if the terminals are in an electrical connection relation. If the positions between element faces, edge lines and edge points are separated from each other even though the terminals are in an electrical connection relation, however, computation errors included in the results of Eqs. (35), (36), (37) and (38) increase, giving rise to an undesirable condition. Thus, it is desirable to have a configuration in which each element face, each edge line and each edge point which compose terminals by electrical connections between conductors are in an error range of the computation function of the analysis computation apparatus 1 or that each element face, each edge line and each edge point exist at distances within an error acceptable range determined in advance. The error acceptable range determined in advance is not greater than approximately 1/10000 times the size of 1 element. Each element face, each edge line and each edge point which exist within such an error acceptable range are referred to as connected or linked element faces, edge lines and edge points.

Next, on the basis of the mesh information, the adjacency-relation information and the terminal-position information, the tree/co-tree processing section 102 carries out tree/co-tree processing at a step S104 to perform tree/co-tree disassembling processing on the object of the analysis and to create a tree/co-tree conversion matrix for extracting independent unknown variable components of current vector potentials. In this case, the tree/co-tree processing section 102 generates the tree/co-tree conversion matrix also including the fact that no current flows out and in through the surface of the object of the analysis. Then, the tree/co-tree processing section 102 makes use of the generated tree/co-tree conversion matrix to carry out reduction computation on the matrixes of Eqs. (35) to (38).

Then, at a step S105, the dependence-condition processing section 103 makes use of the terminal information and results of the tree/co-tree processing to carry out dependence-condition processing to extract independent unknown variable components of current vector potentials composing the terminals. In addition, the dependence-condition processing section 103 makes use of the extracted independent unknown variable components and the terminal information to obtain values of results of computations carried out on Eqs. (40) and (59). The dependence-condition processing section 103 determines dependent components like unknown variable components of current vector potentials at the vector tail and extracts independent unknown variable components by combining Eqs. (40) and (59) in order to generate a dependence condition conversion matrix. Then, the dependence-condition processing section 103 makes use of the generated dependence condition conversion matrix in order to further reduce the matrixes obtained by reducing Eqs. (35) to (38). Thus, the dependence-condition processing section 103 computes coefficient matrixes to be used in Eqs. (46) and (48). It is to be noted that Eq. (40) which is a terminal-current equation is the same as Eq. (51) and the dependence-condition processing section 103 computes W included in a power-supply term vector of Eq. (39) from Eq. (40).

Then, at a step S106, the solution-substitution/erasure processing section 104 computes the inverse matrix of the coefficient matrix of Eq. (44) which is a Poisson equation by adoption of the Gauss direct elimination method and computes C_{T}^{t}C⁻¹C_{T} by multiplying Eq. (44) by C_{T}^{t} on the left side and multiplying Eq. (44) by C_{T} on the right side in order to carry out displacement-current scalar potential form solution substitution and elimination processing (referred to as solution substitution/elimination processing). Thus, all coefficient matrixes of Eq. (48) are obtained and a displacement current in mesh structures according to first to seventh embodiments to be described later is computed.

Then, at a step S107, the frequency-characteristic processing section 105 specifies certain frequencies and solves Eq. (48) which is a matrix at the specified frequencies. Then, the frequency-characteristic processing section 105 carries out frequency-characteristic computation to compute the frequency characteristic of the impedance and store the frequency characteristic. It is to be noted that, after the solution has been obtained, the frequency-characteristic processing section 105 does not have to store a coefficient matrix for a solution other than the obtained solution and a vector. In addition, the frequency-characteristic processing section 105 stores a current vector potential solution of a specific frequency in the storage apparatus 4. The current vector potential solution is a solution output during the computation of the frequency characteristic.

Then, at a step S108, the display processing section 108 carries out frequency-characteristic display processing to display the frequency characteristic of the impedance on the display apparatus 2. The frequency characteristic of the impedance is an output of the step S107.

Then, at a step S109, the processing section 100 determines whether or not to carry out various kinds of processing such as current distribution processing or magnetic-field distribution processing. The determination as to whether or not to carry out the various kinds of processing is based on information received from the input apparatus 3. For example, the user looks at the impedance frequency characteristic displayed at the step S108 and determines whether or not it is necessary to compute a variety of distributions and display the computed distributions. Then, if the user determines that it is necessary to compute a variety of distributions and display the computed distributions, the user typically selects a distribution computation button displayed on the display apparatus 2 to carry out the processing of steps S110 and S111.

If the result of the determination at the step S109 indicates that it is not necessary to carry out a variety of distribution processes (that is S109→No), the processing section 100 ends the processing.

If the result of the determination at the step S109 indicates that it is necessary to carry out a variety of distribution processes (that is S109→Yes), on the other hand, at the step S110, the current-distribution processing section 106 computes current distributions (an eddy-current distribution and a displacement-current distribution) according to Eq. (31) whereas the display processing section 108 displays the computed current distributions on the display apparatus 2. The current-distribution processing section 106 computes the current distributions by making use of a dependence condition conversion matrix and a tree/co-tree conversion matrix for current vector potential solutions computed at the stage of the step S107. The computed current distributions are an eddy-current distribution and a displacement-current distribution. In addition, the current-distribution processing section 106 computes displacement current scalar potentials from Eq. (45) and displays also a displacement-current distribution according to Eq. (32).

Then, at the step S111, the magnetic-field/electrical-field distribution processing section 107 makes use of the current distributions obtained as a result of the computation carried out at the step S110 in order to compute a magnetic-field distribution in accordance with Eq. (6) and compute an electrical-field distribution in accordance with Eq. (58) whereas the processing section 100 carries out magnetic-field distribution processing and electrical-field distribution processing to display the computed magnetic-field distribution and the computed electrical-field distribution on the display apparatus 2. Finally, the processing section 100 ends the processing.

### EMBODIMENTS

The following description explains a concrete example of the mesh configuration generated at the step S101.

### First Embodiment

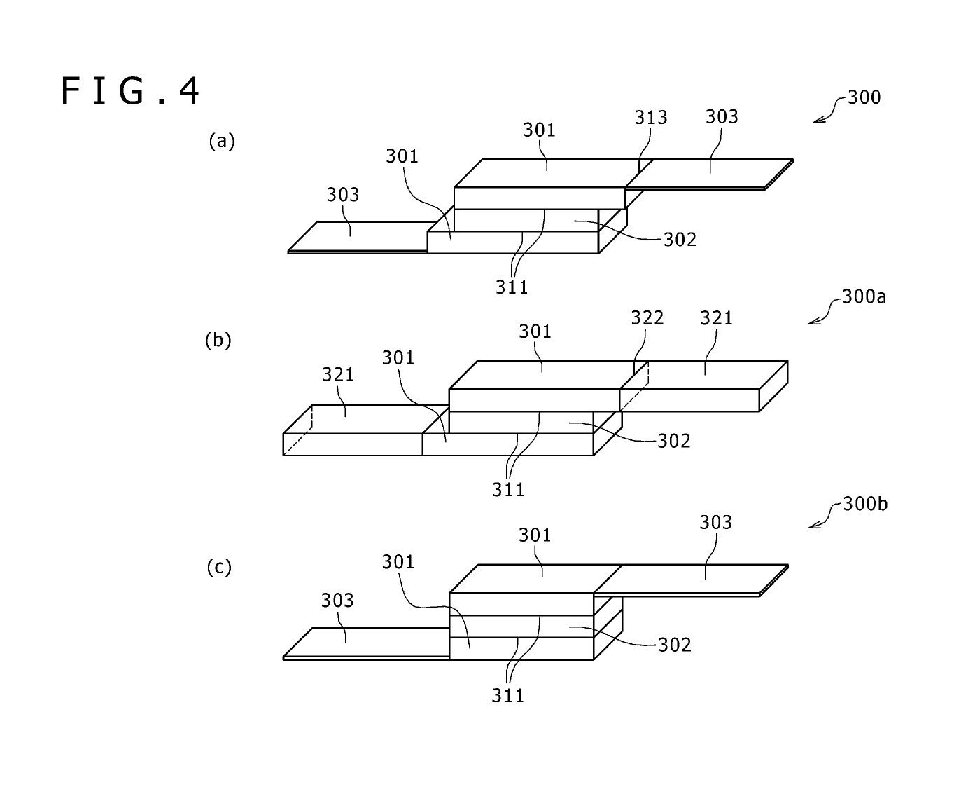

FIG. 4 is diagrams each showing an example of a computation-system configuration model according to a first embodiment.

A computation-system configuration model 300 (corresponding to an analysis object explained before) has a 3-dimensional conductor section 301 (a 3-dimensional mesh structure section), a 3-dimensional insulator section 302 (a 3-dimensional mesh structure section) and a 2-dimensional conductor section 303 (a low-dimension mesh structure section). The 3-dimensional conductor section 301 is a 3-dimensional mesh structure section taking a conductor portion as a 3-dimensional mesh structure. The 3-dimensional insulator section 302 is a 3-dimensional solid configuration insulator section taking an insulator portion clipped in a state of being brought into contact with the 3-dimensional conductor section 301 as a 3-dimensional mesh structure. The 2-dimensional conductor section 303 is a 2-dimensional mesh structure section taking a conductor portion as a 2-dimensional mesh structure. Between the 3-dimensional element face of the 3-dimensional conductor section 301 and the 3-dimensional element face of the 3-dimensional insulator section 302, a connection face 311 exists. In addition, between the 3-dimensional element face of the 3-dimensional conductor section 301 and the 2-dimensional element edge of the 2-dimensional conductor section 303, a connection line 313 exists.

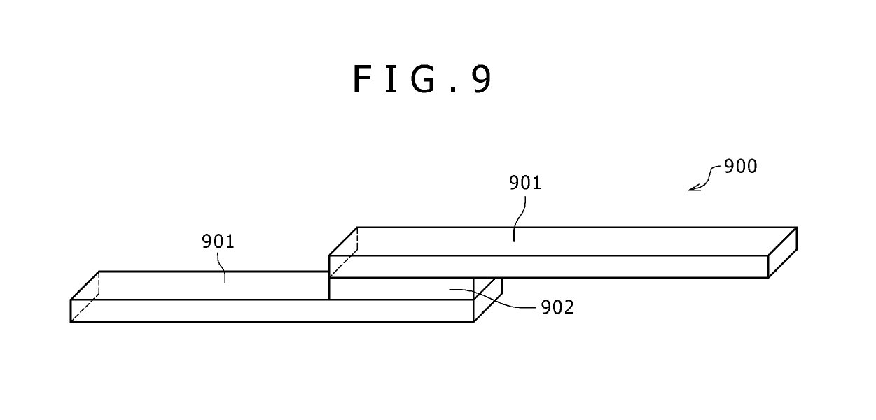

In this case, the 2-dimensional conductor section 303 actually has a 3-dimensional configuration as shown in FIG. 9 and is the same member as the 3-dimensional conductor section 301. Since the 2-dimensional conductor section 303 exists at a location separated away from the insulator body denoted by reference numeral 302 in FIG. 4 (a), however, the effect of the displacement current is so small that the effect can be ignored. Thus, the 2-dimensional conductor section 303 is approximated by a 2-dimensional element so that the processing load of the analysis computation can be reduced.

That is to say, in the original analysis object, the portion of actually the same member (typically configured as a single-body conductor member) is divided into the 3-dimensional conductor section 301 and the 2-dimensional conductor section 303 whereas the 3-dimensional conductor section 301 and the 2-dimensional conductor section 303 are connected to each other by a connection line 313. It is to be noted that, the configuration is not limited to what is described above. That is to say, in the object of the analysis, the 3-dimensional conductor section 301 and the 2-dimensional conductor section 303 can also be members different from each other from the beginning.

In addition, as shown in FIG. 4 (b), the 2-dimensional conductor 301 shown in FIG. 4 (a) is configured from a 2-dimensional element of a surface only and can also be taken as a midair conductor section 321 having a midair inside. Between the midair conductor section 321 and the 3-dimensional conductor section 301, a connection line 322 exists. Since other configuration elements are the same as those shown in FIG. 4 (a), their explanations are omitted.

In addition, in the case of FIG. 4 (a), the effect of the 3-dimensional current is taken into consideration and the 3-dimensional conductor section 301 has a 3-dimensional element till a position at which the 3-dimensional conductor section 301 is shifted from the 3-dimensional insulator section 302. As shown in FIG. 4 (c), however, it is possible to provide a configuration in which the 3-dimensional insulator section 302 overlaps the 3-dimensional conductor section 301 completely. Since other configuration elements are the same as those shown in FIG. 4 (a), their explanations are omitted.

That is to say, it is possible to provide any configuration as long as, at least, a portion brought into contact with the 3-dimensional insulator section 302 has been converted into a 3-dimensional mesh.

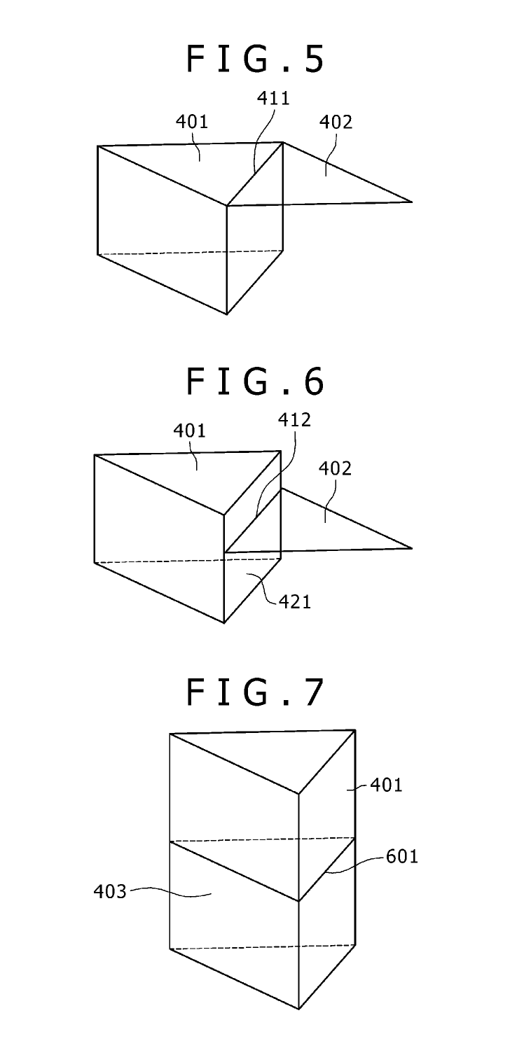

FIG. 5 is a diagram showing a state of inter-element connections of connection lines shown in FIG. 4 (a).

In a link structure between elements on the connection line 313 shown in FIG. 4, a 3-dimensional element 401 in the 3-dimensional conductor section 301 shown in FIG. 4 (a) is connected to a 2-dimensional element 402 in the 2-dimensional conductor section 303 shown in FIG. 4 (a) by a connection line 411.

In addition, FIG. 6 is a diagram showing another typical state of inter-element connections of the connection line 313 shown in FIG. 4 (a).

In FIG. 6, reference numerals 401 and 402 are the same elements as shown in FIG. 5, so their explanations are omitted.

In FIG. 6, unlike FIG. 5, the connection line 412 of the 3-dimensional element 401 and the 2-dimensional element 402 is placed typically inside an element face 421 of the 3-dimensional element 401 instead of being placed above the 3-dimensional element 401 as shown in FIG. 5.

It is to be noted that the configuration is not limited to those shown in FIGS. 5 and 6. That is to say, the connection line 412 can be placed at any location on the element face 421. For example, the connection line 412 can also be placed below the element face 421.

FIG. 7 is a diagram showing a state of inter-element connections of connection lines between the 3-dimensional conductor section and the 3-dimensional insulator section which are shown in FIG. 4 (a).

As shown in FIG. 7, an face of the 3-dimensional element 401 composing the 3-dimensional conductor section 301 shown in FIG. 4 (a) and an face of the 3-dimensional element 403 composing the 3-dimensional insulator section 302 shown in FIG. 4 (a) are connected to each other on a connection face 601.

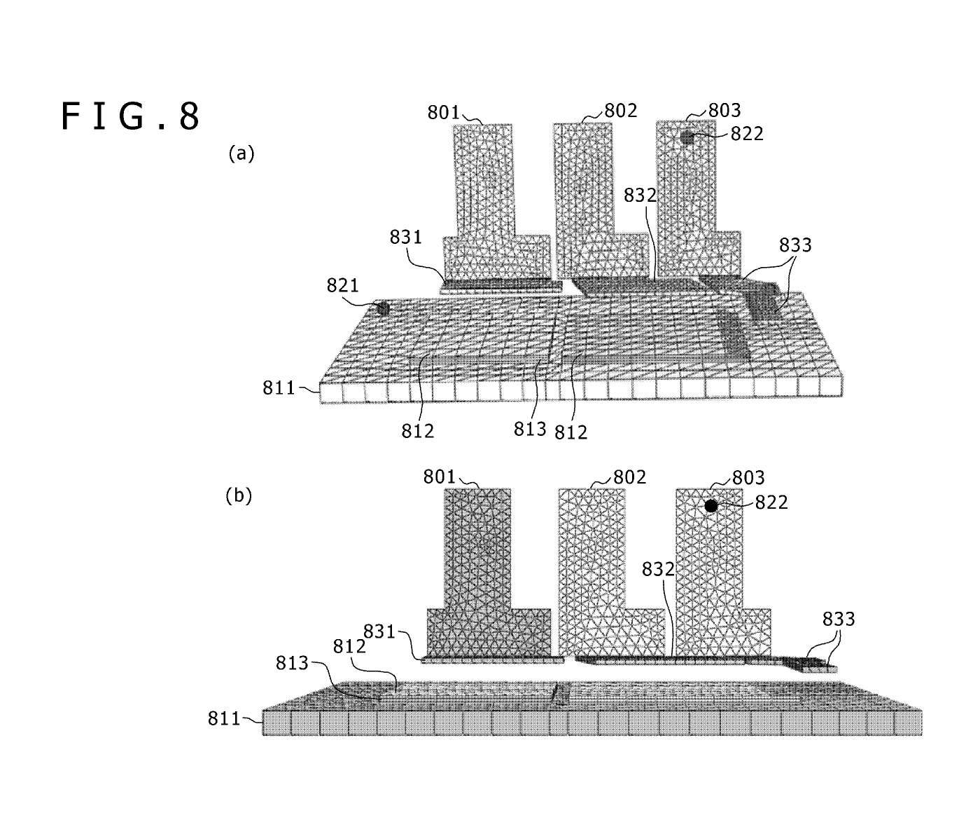

FIG. 8 is diagrams each showing a concrete example of a mesh configuration according to the first embodiment.

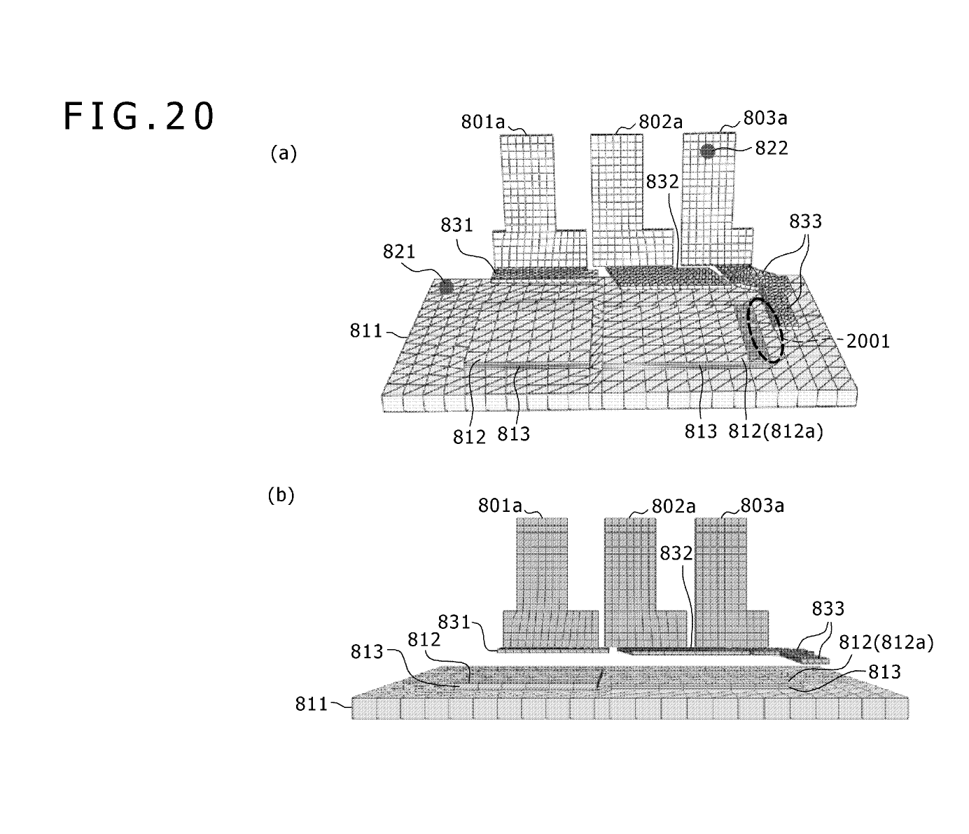

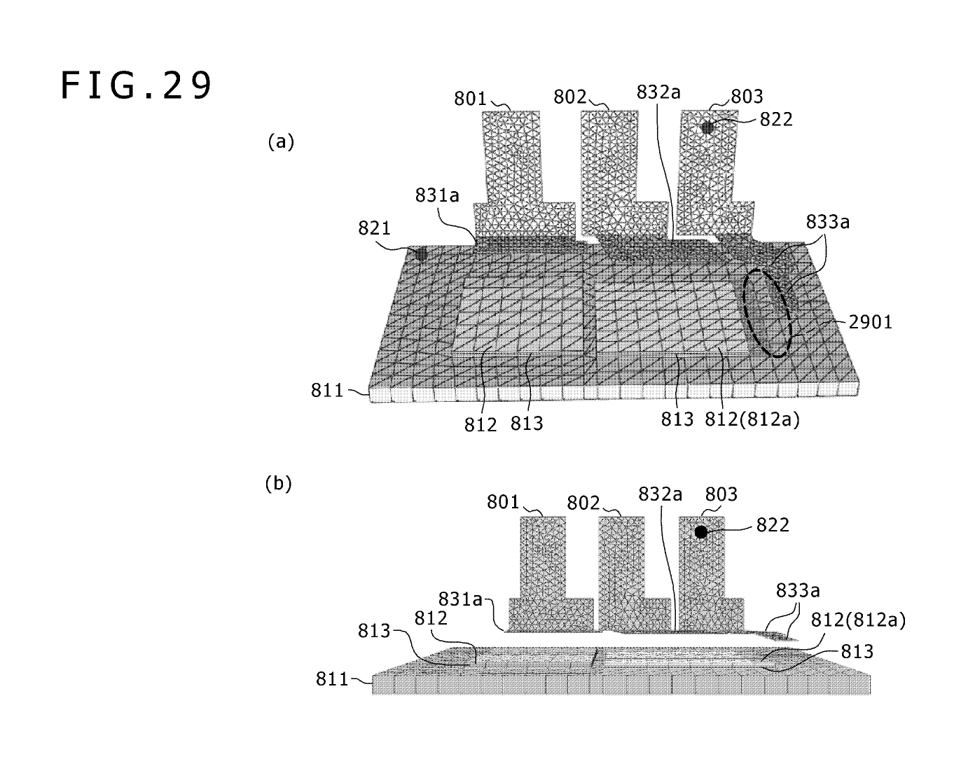

To be more specific, FIG. 8 (a) is a perspective-view diagram showing a mesh structure obtained by converting an analysis object serving as a base into a mesh. On the other hand, FIG. 8 (b) is a front-view diagram showing a mesh structure. The base has a first wiring 801, a second wiring 802, a third wiring 803, a base metal 811 and 2 element pads 812. In this configuration, the third wiring 803 has a terminal 822 whereas the base metal 811 has a ground terminal 821 which serves as an output terminal. In addition, the first wiring 801, the second wiring 802 and the third wiring 803 have wiring connection sections 831 to 833. As shown in FIG. 8 (b), between the wiring connection sections 831 to 833 and the base metal 811, a 3-dimensional insulator section exists. (However, FIG. 8 does not show the 3-dimensional insulator section between the wiring connection sections 831 to 833 and the base metal 811. This holds true of configurations shown in FIGS. 20 and 29 to be described later.) In addition, between the element pad 812 which is a conductor and the base metal 811, an insulator 813 exists.

In this configuration, the base metal 811, the element pad 812, the insulator 813 and the wiring connection sections 831 to 833 are converted into a mesh by 3-dimensional elements whereas the first wiring 801, the second wiring 802 and the third wiring 803 are converted into a mesh by 2-dimensional elements. That is to say, between the first wiring 801, the second wiring 802 and the third wiring 803 and the wiring connection sections 831 to 833, connections explained earlier by referring to FIGS. 4 to 6 as connections to 3-dimensional elements and 2-dimensional elements are used.

When an AC voltage is applied between a terminal 822 serving as an input terminal and a ground terminal 821 serving as an output terminal, the first wiring 801 and the second wiring 802 each become a floating conductor. At that time, when computing the impedance characteristic of an AC current flowing by way of the third wiring 803 and the base metal 811 through a path from the terminal 822 to the ground terminal 821, the mesh configuration shown in FIG. 8 is adopted.

FIG. 9 is a diagram showing a typical computation-system configuration model according to a commonly known example.

The computation-system configuration model 900 is obtained by converting a computation object similar to that shown in FIG. 4 into an element model and is an example used in computation of an electrostatic field. The computation-system configuration model 900 has a midair conductor section 901 which is a conductor section of a midair mesh and a 3-dimensional insulator section 902.

In FIG. 9, the 3-dimensional insulator section 902 has a 3-dimensional mesh structure as is the case with the 3-dimensional conductor section 301 and the 3-dimensional insulator section 302 which are shown in FIG. 4. However, the midair conductor section 901 is configured from 2-dimensional elements on the surface only in the same way as the midair conductor section 321 shown in FIG. 4 (b). Thus, the midair conductor section 901 has a midair inside.

Since the midair conductor section 901 is one of 2-dimensional mesh structures, as shown in FIG. 9, the same member in the comparison example is configured as a 3-dimensional mesh structure or a 2-dimensional mesh structure and the mesh structure of another dimension is not applied to the same member.

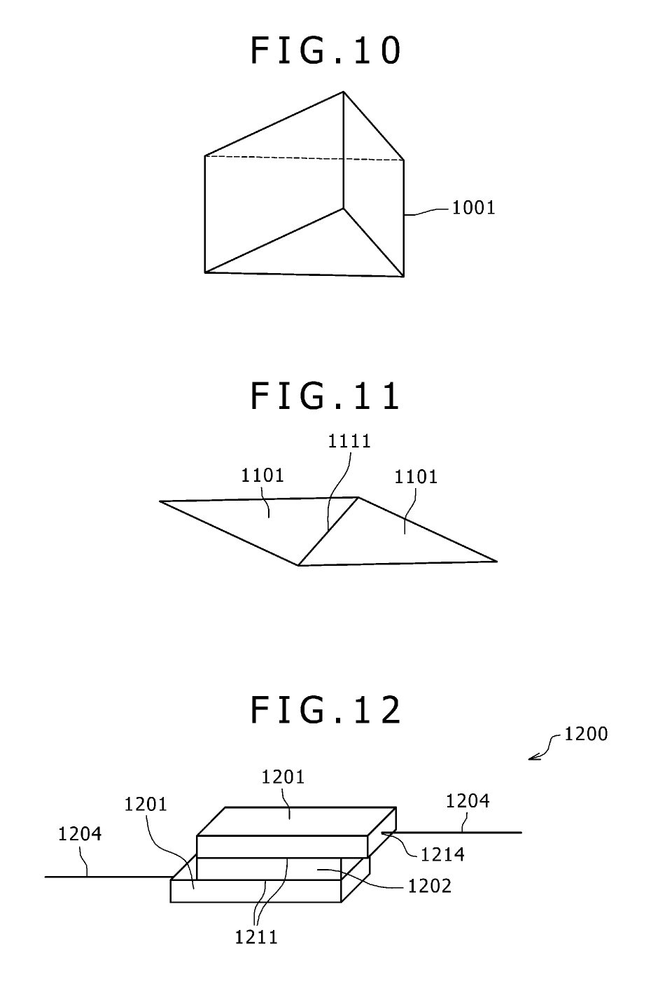

FIGS. 10 and 11 are each a diagram showing elements of a comparison example.

To be more specific, FIG. 10 shows a 3-dimensional element 1001 of a 3-dimensional insulator section 902 whereas FIG. 11 shows 2-dimensional elements 1101 connected to each other by a connection line 1111 to serve as 2-dimensional elements of the midair conductor section 901.

As described above, in the same member in the comparison example, a computation system configuration model is configured from only 3-dimensional members or only 2-dimensional members. If used in computation of a current displacement current, with only 3-dimensional members, the computation load increases but, with only 2-dimensional members, the precision decreases. In the first embodiment, on the other hand, even for the same member, at locations at which it is desired to increase the precision, the mesh is configured from 3-dimensional elements only. At locations at which it is not necessary to much increase the precision, the mesh is configured from 2-dimensional elements. Thus, the technology according to this embodiment is capable of reducing the computation load without decreasing the precision.

### Second Embodiment

A second embodiment of the present invention is explained as follows.

FIG. 12 is a diagram showing an example of a computation-system configuration model according to the second embodiment.

In the same way as that shown in FIG. 4 (a), the computation-system configuration model 1200 shown in FIG. 12 has a 3-dimensional conductor section 1201 (a 3-dimensional mesh structure section), a 3-dimensional insulator section 1202 (a 3-dimensional mesh structure section), a connection surface 1211, a 1-dimensional conductor section 1204 (a low-dimension mesh structure section), a 3-dimensional element face of the 3-dimensional conductor section 1201 and a connection point 1214. The 3-dimensional conductor section 1201 is a 3-dimensional mesh structure section identical with that shown in FIG. 4 (a). The 3-dimensional insulator section 1202 is clipped in a state of being brought into contact with the 3-dimensional conductor section 1201. The 1-dimensional conductor section 1204 is a 1-dimensional linear state approximation conductor. The connection point 1214 is a connection section of a 1-dimensional element edge point of the 1-dimensional conductor section 1204.

The 1-dimensional conductor section 1204 may one-dimensionally approximate a wire or the like. In a 3-dimensional conductor having a width and a thickness, however, if the behavior of the current is simple, the 1-dimensional conductor section 1204 may also approximate one-dimensionally. It is to be noted that the 3-dimensional conductor section 1201 and the 1-dimensional conductor section 1204 may be different members from the beginning or actually the same member. However, the 3-dimensional conductor section 1201 and the 1-dimensional conductor section 1204 may be separated from each other and connected at the connection point 1214 to each other. It is to be noted that, in FIG. 12, in the same way as FIG. 4 (a), the 3-dimensional conductor section 1201 is configured as a 3-dimensional mesh till a location at which the 3-dimensional conductor section 1201 is shifted away from the 3-dimensional insulator section 1202. However, it is nice that at least a portion brought into contact with the 3-dimensional insulator section 302 is configured as a 3-dimensional mesh. As an alternative, it is possible to provide a configuration in which the 3-dimensional conductor section 1201 overlaps the 3-dimensional insulator section 1202 completely as shown in FIG. 4 (c).

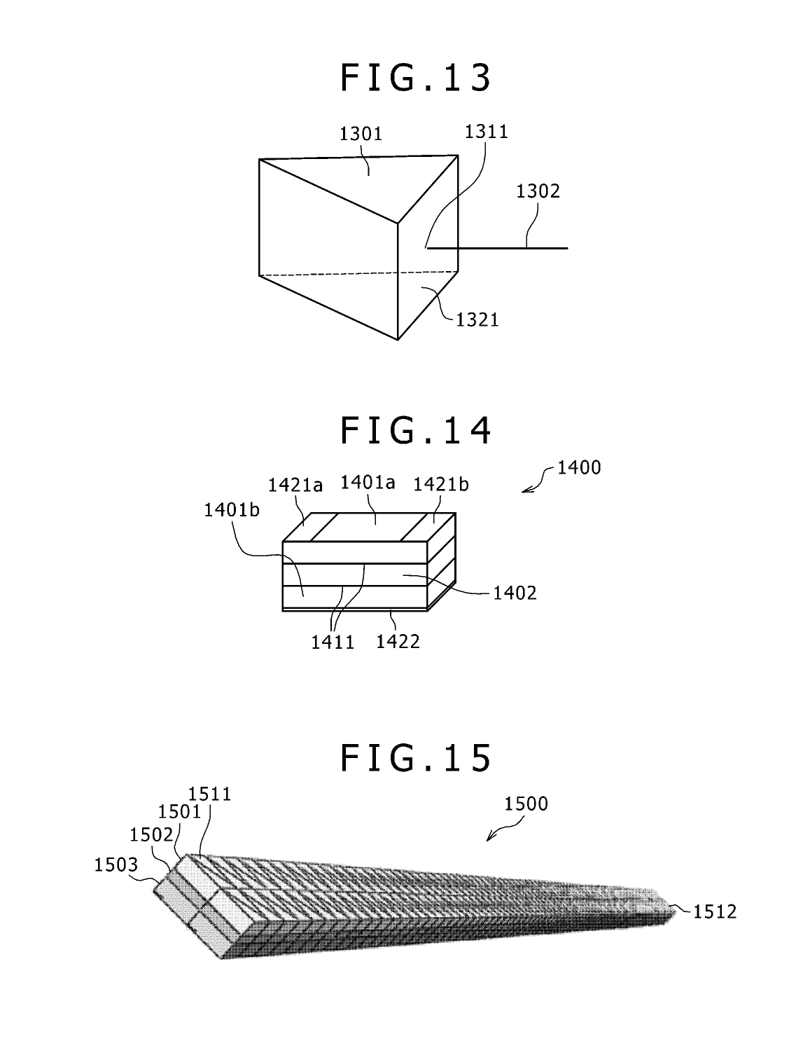

FIG. 13 is a diagram showing a state of inter-element connections at connection points in the example shown in FIG. 12.

As shown in FIG. 13, a 3-dimensional element 1301 in the 3-dimensional conductor section 1201 shown in FIG. 12 is connected to a 1-dimensional element 1302 in the 1-dimensional conductor section 1204 shown in FIG. 12 through a connection face 311.

A connection point 1311 in FIG. 13 is placed at the center of the element face 1321 of the 3-dimensional element 1301. It is to be noted, however, that the connection point 1311 may also be placed at a location other than the center.

In accordance with the second embodiment, by approximation to a 1-dimensional conductor, the computation load can be further reduced.

### Third Embodiment

FIG. 14 is a diagram showing an example of a computation-system configuration model according to a third embodiment.

In the same way as that shown in FIG. 4 (a), the computation-system configuration model 1400 has a 3-dimensional conductor sections 1401a, 1401b, a 3-dimensional insulator section 1402, and a connection face 1411. Further, the 3-dimensional conductor section 1401b has a ground terminal 1422 which is an output terminal whereas the 3-dimensional conductor section 1401a has 2 terminals 1421a and 1421b which are each an input terminal. That is to say, the computation-system configuration model 1400 according to the third embodiment has 3 terminals. The example shown in FIG. 14 has the 3 terminals 1421a, 1421b and 1422. It is to be noted, however, that, the computation-system configuration model 1400 may also have a structure provided with 3 or more terminals. In addition, on the edge faces of the 3-dimensional conductors 1401a and 1401b shown in FIG. 14, nothing is connected. However, it is possible to connect a 2-dimensional conductor like the one of the first embodiment or a 1-dimensional conductor like the one of the second embodiment.

FIG. 15 is a diagram showing a concrete example of a mesh configuration of a 3-dimensional conductor and a 3-dimensional insulator.

A mesh structure body 1500 has a structure clipped in a state in which a 3-dimensional insulator section 1502 is brought into contact with 3-dimensional conductor sections 1501 and 1503. In this configuration, the 3-dimensional conductor sections 1501 and 1503 correspond to the 3-dimensional conductor sections 1401a and 1401b shown in FIG. 14 whereas the 3-dimensional insulator section 1502 corresponds to the 3-dimensional insulator section 1402. By setting a ground terminal and terminals like the ones shown in FIG. 14 in such a mesh structure body 1500, it is possible to configure a computation mesh that can be used in computation of the impedance characteristic of a strip line. It is to be noted that reference numerals 1511 and 1512 each denote a terminal whereas the bottom face of the mesh structure body 1500 serves as the ground terminal.

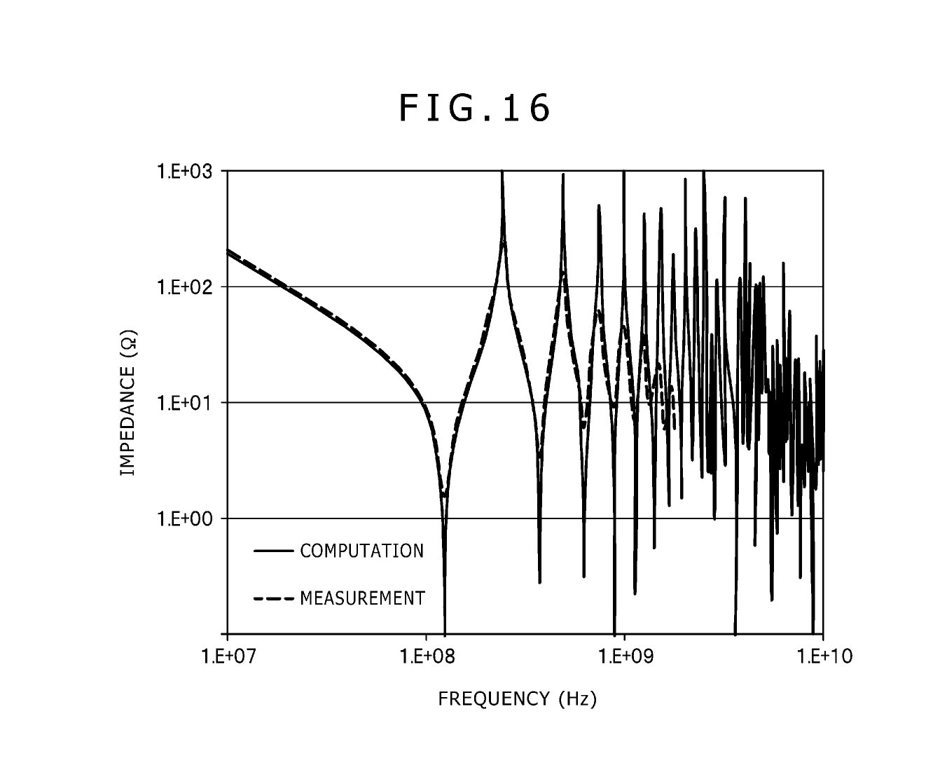

FIG. 16 is a diagram to be referred to in explanation of a typical frequency-characteristic computation result for a mesh structure body.

In FIG. 16, the horizontal axis represents the frequency (expressed in terms of Hz units) of a voltage applied between the terminal 1511 shown in FIG. 15 and the terminal 1512 also shown in FIG. 15 whereas the vertical axis represents the impedance (expressed in terms of Q hunits) between a terminal and the ground terminal.

The frequency characteristic shown in FIG. 16 is a frequency characteristic obtained by taking the entire bottom face of the 3-dimensional conductor section 1503 shown in FIG. 15 as the ground terminal and by taking the elements denoted by reference numerals 1511 and 1512 in FIG. 15 as terminals.

A solid-line graph represents a computation result obtained by adoption of a computation analysis method according to this embodiment whereas a dash-line curve represents an actual-measurement result.

In FIG. 16, the computation result agrees with the actual-measurement result for resonance frequencies till the vicinity of 1 G (1.E+0.9) and an anti-resonance frequency of within 4%. In this computation example, the resonance/anti-resonance peak value (the protruding portion of the computation result) does not match the actual-measurement result mainly because the attenuation effect of the dielectric substance is not taken into consideration and not because of denial of the effectiveness of this embodiment. In order to introduce this effect, it is necessary to consider imaginary-number components representing the attenuation effect in the elastance matrix.

As shown in FIG. 16, in accordance with the analysis computation method according to this embodiment, it is possible to carry out an analysis and computation on the frequency characteristic and, in particular, the resonance and anti-resonance frequencies with a high degree of precision.

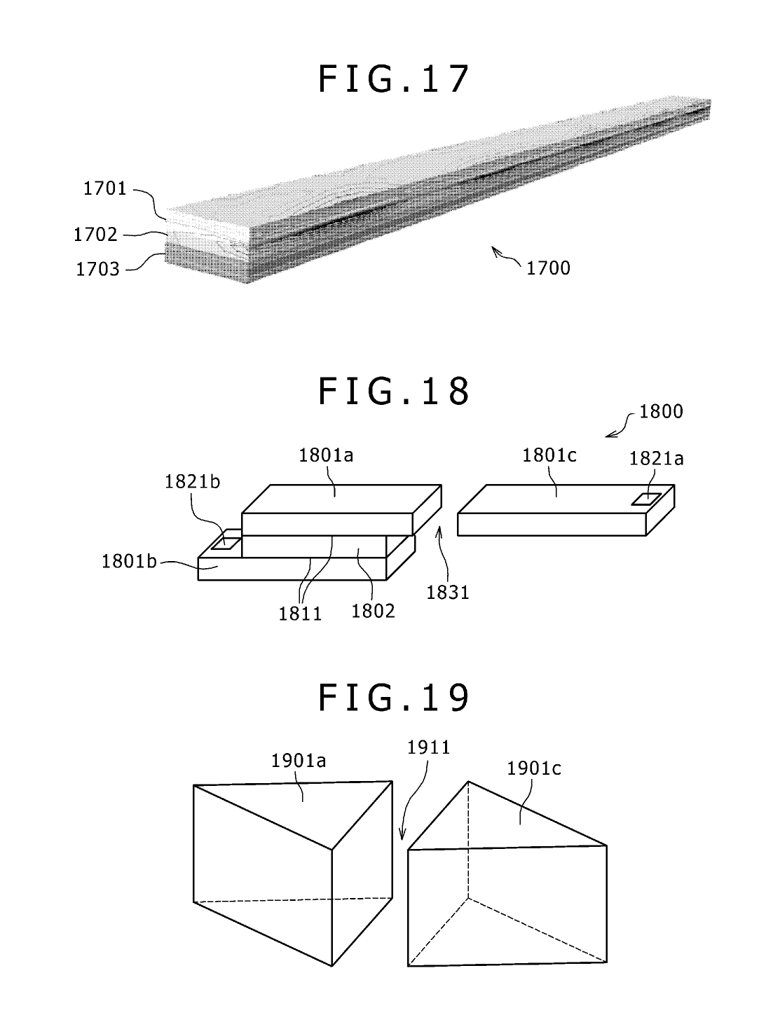

FIG. 17 is a diagram showing a typical result of eddy-current distribution computation carried out by making use of the mesh structure shown in FIG. 15.

In a mesh structure body 1700, 3-dimensional conductor sections 1701 and 1703 correspond respectively to the 3-dimensional conductor sections 1501 and 1503 shown in FIG. 15 whereas a 3-dimensional conductor section 1702 corresponds to the 3-dimensional conductor section 1502 shown in FIG. 15.

FIG. 17 shows a current-density absolute-value distribution obtained by supplying a voltage with a frequency of 3.3 MHz to the terminals. In this way, it is possible to compute and display an eddy-current distribution by adoption of the computation analysis method according to this embodiment.

In accordance with the third embodiment, for an analysis object having a plurality of terminals, it is possible to configure a mesh and carry out analysis computation.

It is to be noted that the same setting of a plurality of terminals as that carried out in the third embodiment can also be adopted in other embodiments.

### Fourth Embodiment

FIG. 18 is a diagram showing an example of a computation-system configuration model according to a fourth embodiment.

In the same way as that shown in FIG. 4 (a), a computation-system configuration model 1800 has 3-dimensional conductor sections 1801a and 1801b (first mesh structure sections), a 3-dimensional insulator section 1802 (a first mesh structure section), a connection face 1811, a 3-dimensional conductor section 1801c (a second mesh structure section), a ground terminal 1821b and a terminal 1821a. The 3-dimensional insulator section 1802 is clipped in a state of being brought into contact with the 3-dimensional conductor sections 1801a and 1801b. Between the 3-dimensional conductor section 1801c and the 3-dimensional conductor section 1801a, a short-circuit section 1831 exists. Actually, a conductor exists between the 3-dimensional conductor section 1801c and the 3-dimensional conductor section 1801a. However, for an area in which mesh elements can be approximately eliminated, the elements are eliminated. Thus, a short-circuit section 1831 having mesh elements eliminated (having a mesh structure not set) is provided. At an actual computation time, computation is carried out on the assumption that the 3-dimensional conductor section 1801c and the 3-dimensional conductor section 1801a have been brought into direct contact with each other. This state is referred to as a state of being connected by eliminating elements or a state of being connected by elimination.

It is desirable to have a configuration in which the distance of the short-circuit section 1831 is a distance at which effects of the inductance, the resistance and the elastance can be approximately ignored. To put it concretely, it is desirable to have a configuration wherein the distance at which effects of the inductance, the resistance and the elastance can be approximately ignored is such a distance that, when seen along a current path, the change of the wiring length/the current-circuit area is within 10%. This can be approximately estimated by the user prior to computation from a member size. In addition, after computation based on the state of being connected by elimination, it is also possible to carry out the estimation from a current distribution.

In this case, the connection face 1811 has been connected in the same way as, among others, reference numeral 311 (FIG. 4), reference numeral 601 (FIG. 7), reference numeral 1211 (FIG. 12) and reference numeral 1411 (FIG. 14). If electrical connection can be obtained on the basis of a current continuity condition, the computation itself is possible. Even if the connection face 1811 is changed to the state of being connected by elimination due to a short circuit, however, it is particularly desirable to have a configuration in which the effect of the elastance can be approximately ignored.

FIG. 19 is a diagram showing an inter-element connection state in a short-circuit section shown in FIG. 18.

As shown in FIG. 19, between the 3-dimensional element 1901a on the 3-dimensional conductor section 1801a shown in FIG. 18 and the 3-dimensional element 1901c on the 3-dimensional conductor section 1801c shown in FIG. 18, a short-circuit section 911 exists. As described before, at an actual computation time, computation is carried out on the assumption that the 3-dimensional element 1901c and the 3-dimensional element 1901a have been brought into contact with each other.

FIG. 20 is diagrams each showing a concrete example of a mesh configuration according to the fourth embodiment.

To be more specific, FIG. 20 (a) is a perspective-view diagram showing a mesh structure body obtained by converting a board serving as the object of the analysis into a mesh whereas FIG. 20 (b) is a front-view diagram showing the mesh structure body. Except that a first wiring 801a, a second wiring 802a and a third wiring 803a each have a 3-dimensional mesh structure, the mesh configuration shown in FIG. 20 is identical with that shown in FIG. 8 so that the explanation of the mesh configuration shown in FIG. 20 is omitted.

In the mesh configuration shown in FIG. 20, a short-circuit section 2001 is created between an element pad 812a and a wiring connection section 833. That is to say, even though the element pad 812a and the wiring connection section 833 are actually connected to each other, in the mesh configuration shown in FIG. 20, the connection is omitted and shown as the short-circuit section 2001. At an actual computation time, computation is carried out on the assumption that the element pad 812a and the wiring connection section 833 have been brought into contact with each other.

When an AC voltage is applied between a terminal 822 and a ground terminal 821, a first wiring 801a and a second wiring 802a each become a floating conductor. At that time, when computing the impedance characteristic of an AC current flowing by way of the third wiring 803a and the base metal 811 through a path from the terminal 822 to the ground terminal 821, the mesh configuration shown in FIG. 20 is adopted.

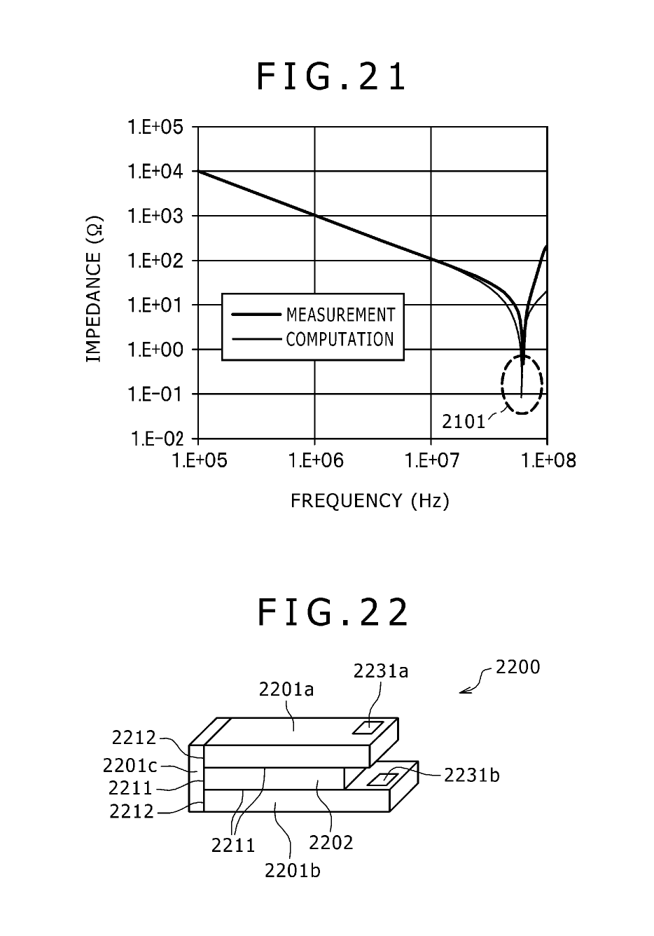

FIG. 21 is a diagram showing a computation result obtained from frequency-characteristic computation carried out by making use of the mesh configuration shown in FIG. 20.

In FIG. 21, the horizontal axis represents the frequency (expressed in terms of Hz units) of a voltage applied to the terminal 822 shown in FIG. 20 whereas the vertical axis represents the impedance (expressed in terms of Ω units) between the terminal 822 and the ground terminal 821 also shown in FIG. 20.

A thin-line graph represents a result of an analysis and computation which are carried out by adoption an analysis computation method. A thick-line graph represents a result of an actual measurement. The impedance resonance frequency obtained by carrying out an actual measurement is 61.6 MHz whereas the impedance resonance frequency obtained by carrying out an analysis and computation is 59.0 MHz. In FIG. 21, from 100 KHz (1.E+05) to a first resonance frequency 2101, the result of the analysis and the computation matches the result of the actual measurement, having an error of 4.3% between the result of the analysis and the computation and the result of the actual measurement. It is to be noted that the actual measurement has been carried out by adoption of a 2-terminal method. At a calibration time, anti-resonance has appeared in the vicinity of 100 MHz (1.E+08). An increase of an error in the vicinity of 100 MHz is caused by a calibration error which is caused by such anti-resonance and is not a denial of the effectiveness of this embodiment.

As shown in FIG. 21, by making use of a mesh configuration according to the fourth embodiment, at least at low frequencies, an analysis and computation can be carried out with a high degree of precision.

In accordance with the fourth embodiment, by providing a short-circuit section, it is possible to reduce the number of locations at which the analysis and the computation are to be carried out and, thus, increase the speed of the analysis and the computation.

### Fifth Embodiment

FIG. 22 is a diagram showing an example of a computation-system configuration model according to a fifth embodiment.

Much like the configuration shown in FIG. 4 (a), the computation-system configuration model 2200 has been clipped in a state in which a 3-dimensional insulator section 2202 has been brought into contact with 3-dimensional conductor sections 2201a and 2201b through a connection face 2221. The 3-dimensional conductor section 2201a is provided with a terminal 2231a serving as an input terminal whereas the 3-dimensional conductor section 2201b is provided with a ground terminal 2231b serving as an output terminal. In addition, the 3-dimensional conductor sections 2201a and 2201b are connected to each other by a 3-dimensional conductor section 2201c. Between a 3-dimensional conductor section 2201c and the 3-dimensional conductor sections 2201a and 2201b, a connection face 2212 exists whereas, between the 3-dimensional conductor section 2201c and the 3-dimensional insulator section 2202, a connection face 2211 exists

That is to say, the configuration shown in FIG. 22 is a configuration in which the terminal 2231a and the ground terminal 2231b are connected to each other by a conductor and, between the terminal 2231a and the ground terminal 2231b, an insulator exists. In addition, FIG. 22 shows a structure including a 3-dimensional insulator section 2202 clipped by the 3-dimensional conductor sections 2201a and 2201b which are continuous to each other. Topologically, however, the structure shown in the figure is the same structure as a structure in which a 3-dimensional insulator section is brought into contact with a 3-dimensional conductor section. Thus, an analysis in such a structure can be carried out. That is to say, even if the 3-dimensional insulator section 2202 is not clipped by the 3-dimensional conductor sections 2201a and 2201b, it is nice to provide a state in which a 3-dimensional insulator section is brought into contact with a 3-dimensional conductor section.

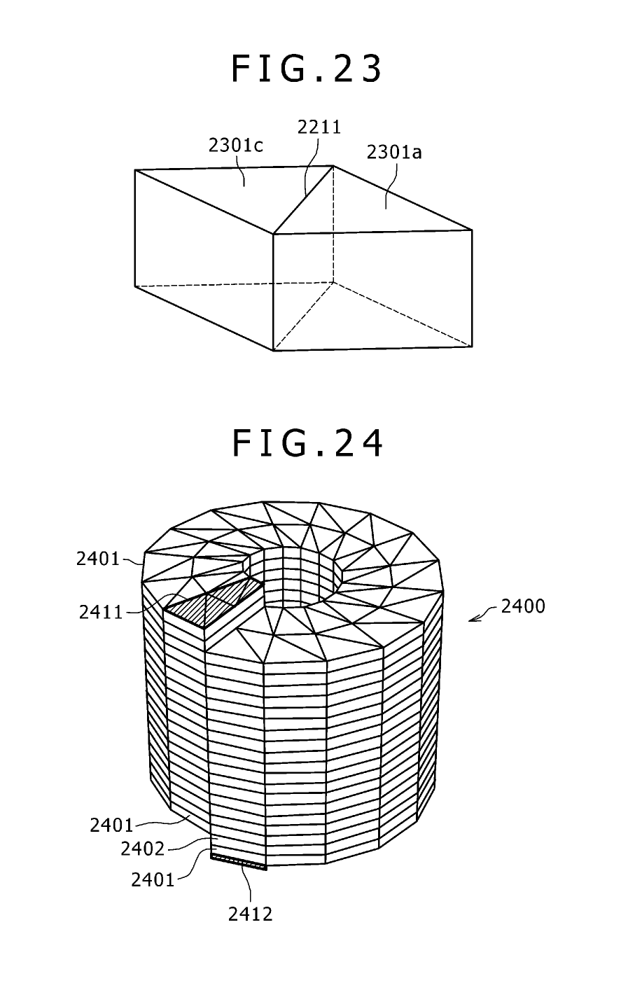

FIG. 23 is a diagram showing a state of inter-element connections on a connection face shown in FIG. 22.

As shown in FIG. 23, a 3-dimensional element 2301a in the 3-dimensional conductor sections 2201a and 2201b shown in FIG. 22 is connected to a 3-dimensional element 2301c in the 3-dimensional conductor section 2201c shown in FIG. 22 through the connection face 2211.

FIG. 24 is a diagram showing a concrete example of a mesh configuration in a structure body having a configuration like the one shown in FIG. 22.

The mesh structure body 2400 has a structure in which a 3-dimensional conductor section 2401 and a 3-dimensional insulator section 2402 overlap each other to create a spiral form. In addition, a terminal 2411 used for applying an AC voltage is provided above the mesh structure body 2400 whereas a ground terminal 2412 is provided beneath the mesh structure body 2400.

The mesh structure body 2400 shown in FIG. 24 has a configuration in which the terminal 2411 and the ground terminal 2412 are connected to each other by a conductor and an insulator exists between the terminal 2411 and the ground terminal 2412. This configuration is identical with that shown in FIG. 22.

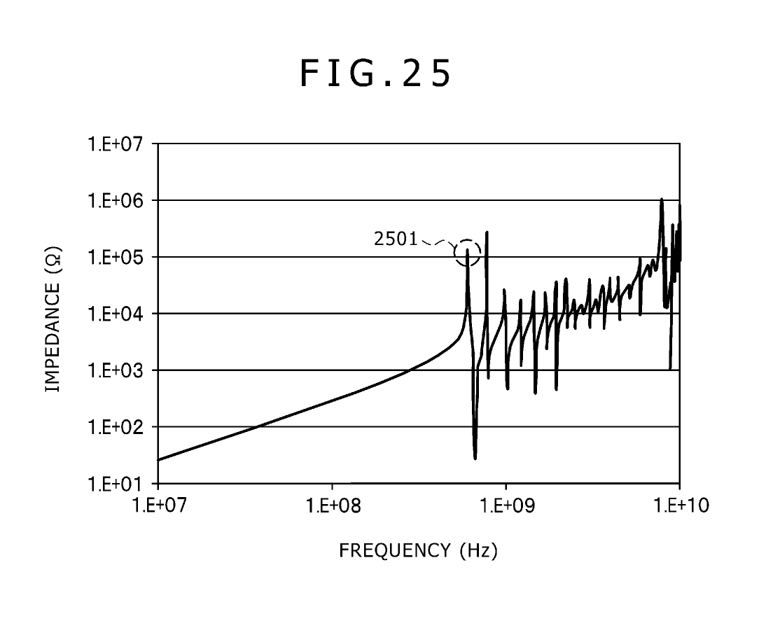

FIG. 25 is a diagram showing typical computation of a frequency characteristic in the fifth embodiment.

FIG. 25 shows a frequency characteristic which is obtained when an AC voltage is applied to the 3-dimensional conductor section 2401 of the mesh structure body 2400 shown in FIG. 24.

In FIG. 25, the horizontal axis represents the frequency (expressed in terms of Hz units) of a voltage applied to the terminal 2411 shown in FIG. 24 whereas the vertical axis represents the impedance (expressed in terms of Ω units) between the terminal 2411 and the ground terminal 2412 also shown in FIG. 20.

As shown in FIG. 25, as the frequency and the impedance increase, a peak 2501 exists as a peak at which a first anti-resonance appears. The peak 2501 is a filter-peculiar result. By carrying out an analysis and computation in accordance with the fifth embodiment, from FIG. 25, it is possible to confirm the fact that the filter-peculiar result is obtained. This is typical verification indicating that it is possible to apply the computation analysis method according to the fifth embodiment to a 3-dimensional mesh structure.

In accordance with the fifth embodiment, even in a configuration wherein terminals are connected to each other by a conductor and an insulator brought into contact with the conductor exists, it is possible to configure a mesh and carry out an analysis and computation.

### Sixth Embodiment

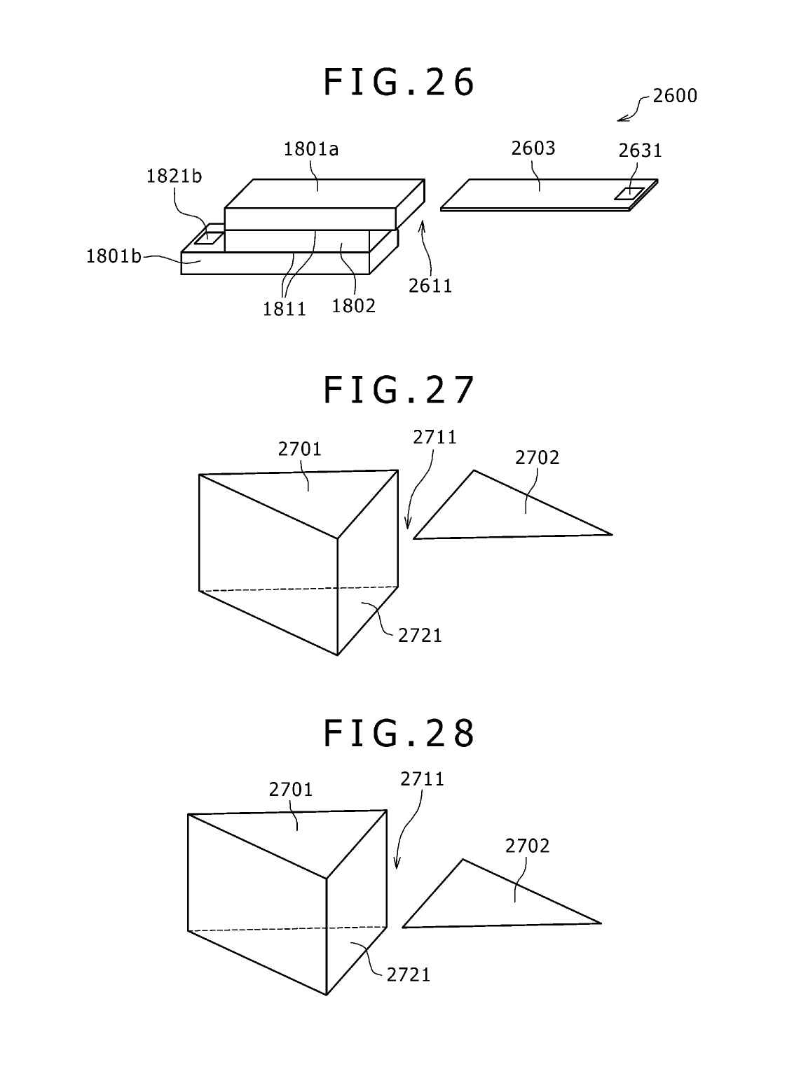

FIG. 26 is a diagram showing an example of a computation-system configuration model according to a sixth embodiment. In FIG. 26, configuration elements identical with their respective counterparts shown in FIG. 18 are denoted by the same reference numerals as the counterparts and explanation of the identical configuration elements is omitted.

The computation-system configuration model 2600 has a configuration identical with that shown in FIG. 18. However, the 3-dimensional conductor section 1801c shown in FIG. 18 becomes a 2-dimensional conductor section 2603 (a second mesh structure section) having a 2-dimensional mesh structure. It is to be noted that the 2-dimensional conductor section 2603 is provided with a terminal 2631 to which a voltage is applied.

In this case, the 3-dimensional conductor section 1801a and the 2-dimensional conductor section 2603 are actually the same member. However, the 3-dimensional conductor section 1801a and the 2-dimensional conductor section 2603 may also be members separated from each other. As another alternative, the 3-dimensional conductor section 1801a and the 2-dimensional conductor section 2603 may also be members different from each other.

In addition, the computation-system configuration model 2600 shown in FIG. 26 has a short-circuit section 2611. Actually, a conductor exists between the 3-dimensional conductor section 1801a and the 2-dimensional conductor section 2603. However, for an area in which mesh elements can be approximately eliminated, the elements are eliminated. Thus, a short-circuit section 2611 having mesh elements eliminated (having a mesh structure not set) is provided. At an actual computation time, computation is carried out on the assumption that the 3-dimensional conductor section 1801a and the 2-dimensional conductor section 2603 have been brought into direct contact with each other.

It is to be noted that the 2-dimensional conductor section may have a midair structure like the one denoted by reference numeral 321 in FIG. 4 (b).

FIGS. 27 and 28 are each a diagram showing a state of inter-element connections in a short-circuit section shown in FIG. 26.

As shown in FIGS. 27 and 28, between a 3-dimensional element 2701 in the 3-dimensional conductor section 1801a shown in FIG. 26 and a 2-dimensional element 2702 in the 2-dimensional conductor section 2603 shown in FIG. 26, a short-circuit section 2711 exists. As described before, at an actual computation time, computation is carried out on the assumption that the 3-dimensional element 2701 and the 2-dimensional element 2702 have been brought into direct contact with each other.

The 2-dimensional element 2702 may exist at a position close to the top of the 3-dimensional element 2701 as shown in FIG. 27 or a position close to the middle of the 3-dimensional element 2701 as shown in FIG. 28. In addition, the location of the 2-dimensional element 2702 is not limited to these positions. That is to say, the 2-dimensional element 2702 can also be placed at any other position as long as the other position is close to an element face 2721 of the 3-dimensional element 2701. For example, the 2-dimensional element 2702 can also be placed at a position beneath the 3-dimensional element 2701 or in a position inclined to the 3-dimensional element 2701.

FIG. 29 is diagrams each showing a concrete example of a mesh configuration according to the sixth embodiment. In FIG. 29, configuration elements identical with their respective counterparts shown in FIG. 8 are denoted by the same reference numerals as the counterparts and explanation of the identical configuration elements is omitted.

To be more specific, FIG. 29 (a) is a perspective-view diagram showing a mesh structure body obtained by converting a board serving as the object of the analysis into a mesh whereas FIG. 29 (b) is a front-view diagram showing the mesh structure body. Except that a wiring connection sections 831a-833a each serve as a 2-dimensional conductor section, the mesh configuration shown in FIG. 29 is identical with that shown in FIG. 8 so that the detailed explanation is omitted.

A short-circuit section 2901 between the wiring connection section 833a and the element pad 812a in the configuration shown in FIG. 29 corresponds to the short-circuit section 2611 shown in FIG. 26.

When an AC voltage is applied between a terminal 822 and a ground terminal 821, a first wiring 801 and a second wiring 802 each become a floating conductor. When computing the impedance characteristic of an AC current flowing by way of the third wiring 803 and the base metal 811 through a path from the terminal 822 to the ground terminal 821, the mesh configuration shown in FIG. 29 is adopted.

FIG. 30 is a diagram showing a result of an analysis and computation which are carried out by making use of mesh configurations created in accordance with the first, fourth and sixth embodiments.

The used mesh configurations are the configuration shown in FIG. 8 for the first embodiment, the configuration shown in FIG. 20 for the fourth embodiment and the configuration shown in FIG. 29 for the sixth embodiment.

In FIG. 30, the horizontal axis represents the frequency (expressed in terms of Hz units) of an applied voltage whereas the vertical axis represents the impedance (expressed in terms of Q units) between a terminal and a ground terminal.

In the figure, a fine dashed line represents analysis and computation results for the sixth embodiment (or the thin-plate electrode shown in FIG. 29) whereas a coarse dashed line represents analysis and computation results for the fourth embodiment (or the thick-plate electrode shown in FIG. 20). A solid line represents analysis and computation results for the first embodiment (or the mix electrode shown in FIG. 8).

The first resonance frequency (a protrusion 3001) of the fine dashed line representing analysis and computation results for the sixth embodiment is 56.7 MHz whereas the first resonance frequency of the coarse dashed line representing analysis and computation results for the fourth embodiment is 60.5 MHz. The first resonance frequency of the solid line representing analysis and computation results for the first embodiment is 59.0 MHz. These first resonance frequencies agree with each other at errors not exceeding 6.2%. Thus, by making use of any of the embodiments, it is possible to carry out an analysis and computation on a conductor to which the contribution of the displacement-current capacitance effect can be ignored.

Computation adopting the analysis method according to the first embodiment shown in FIG. 8 can be carried out at a speed 2.0 times faster than computation adopting the analysis method according to the fourth embodiment shown in FIG. 20. In this way, the effectiveness of the hybrid use of both 2-dimensional elements and 3-dimensional elements as is the case with the first embodiment can be verified.

In addition, computation adopting the analysis method according to the sixth embodiment shown in FIG. 29 can be carried out at a speed 3.4 times faster than computation adopting the analysis method according to the fourth embodiment shown in FIG. 20. In this way, the effectiveness of the hybrid use of both 2-dimensional elements and 3-dimensional elements as is the case with the sixth embodiment can be verified.

In accordance with the sixth embodiment, 2-dimensional elements are used in order to increase the speed of the analysis and the computation. In addition, a short-circuit section is provided in order to further increase the speed of the analysis and the computation.

### Seventh Embodiment

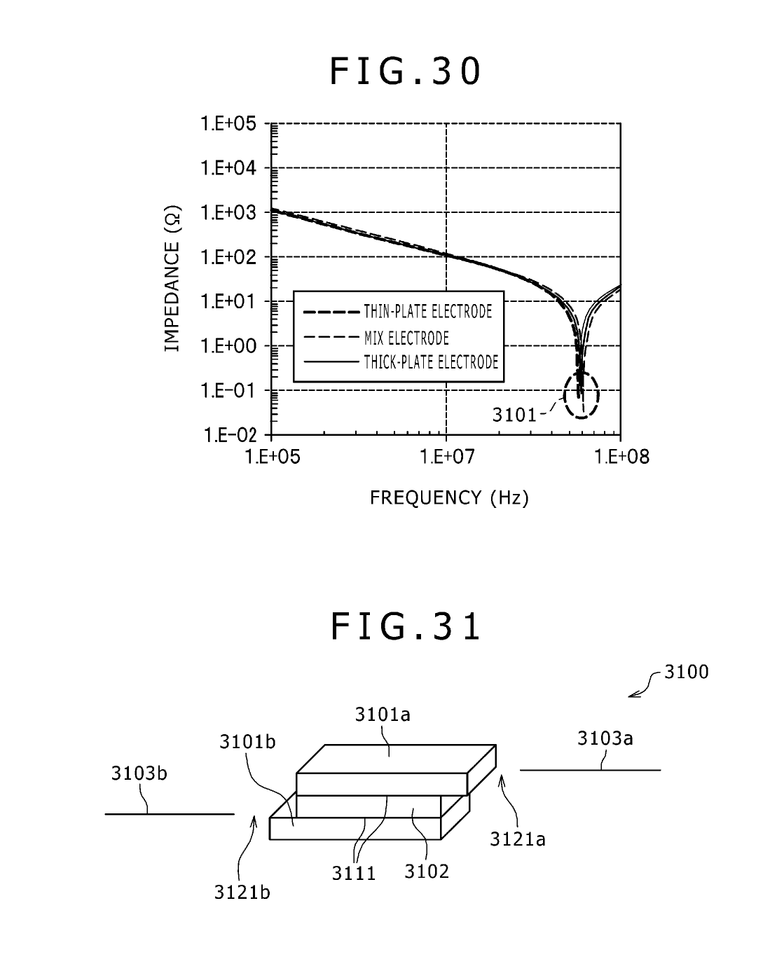

FIG. 31 is a diagram showing an example of a computation-system configuration model according to a seventh embodiment.

In the same way as the configuration shown in FIG. 4 (a), in the computation-system configuration model 3100, a 3-dimensional insulator section 3102 is clipped in a state in which the 3-dimensional insulator section 3102 (a first mesh structure section) has been brought into contact with 3-dimensional conductor sections 3101a and 3101b (first mesh structure sections) through a connection face 3111. In addition, between a 3-dimensional conductor section 3103a (a second mesh structure section) and the 3-dimensional conductor section 3101a, a short-circuit section 3121a exists whereas, between a 1-dimensional conductor section 3103b (a second mesh structure section) and the 3-dimensional conductor section 3101b, a short-circuit section 3121b exists. Actually, a conductor exists between the 3-dimensional conductor section 3101ac and the 3-dimensional conductor section 3103a. However, for an area in which mesh elements can be approximately eliminated, the elements are eliminated. Thus, the short-circuit section 3121a having mesh elements eliminated (having a mesh structure not set) is provided. The above description also holds true of the short-circuit section 3121b. At an actual computation time, computation is carried out on the assumption that the short-circuit sections 3121a and 3121b are short-circuited whereas the 3-dimensional conductor section 3103a and the 1-dimensional conductor section 3103b have been brought into contact with the 3-dimensional conductor section 3101a and the 3-dimensional conductor section 3101b respectively.

In this case, the 3-dimensional conductor section 3101a and the 3-dimensional conductor section 3103a are actually the same member. However, the 3-dimensional conductor section 3101a and the 3-dimensional conductor section 3103a may also be members separated from each other. As another alternative, the 3-dimensional conductor section 3101a and the 3-dimensional conductor section 3103a may also be members different from each other. This description also holds true of the 3-dimensional conductor section 3101b and the 1-dimensional conductor section 3103b.

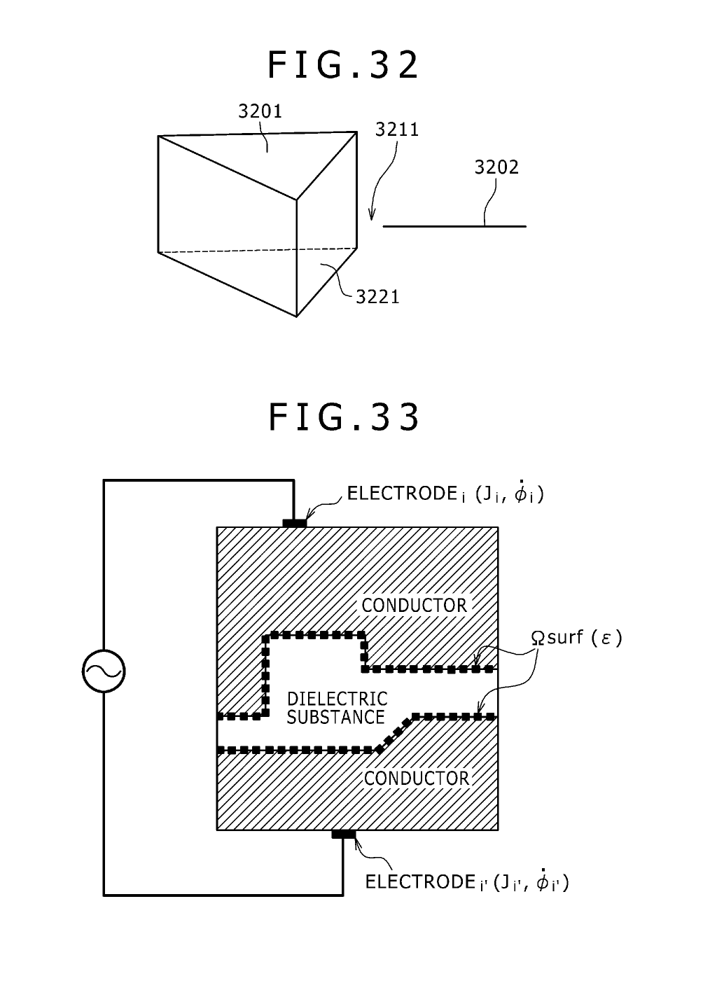

FIG. 32 is a diagram showing a state of inter-element connections in the short-circuit section shown in FIG. 31.

As shown in FIG. 32, between a 3-dimensional element 3201 in the 3-dimensional conductors 3101a and 3101b shown in FIG. 31 and a 1-dimensional element 3202 in the 3-dimensional conductors 3103a and 3103b also shown in FIG. 31, a short-circuit section 3211 exists. As described before, at an actual computation time, computation is carried out on the assumption that the 3-dimensional element 3201 and the 1-dimensional element 3202 have been brought into contact with each other.

As shown in FIG. 32, the 1-dimensional element 3202 can be placed at a position close to the middle of the 3-dimensional element 3201. As an alternative, the 1-dimensional element 3202 can also be placed at a position close to an element face 3221 of the 3-dimensional element 3201 such as a position above the 3-dimensional element 3201 or beneath the 3-dimensional element 3201.

In accordance with the seventh embodiment, by making use of 1-dimensional elements, the speed of the analysis and the computation can be increased and, by providing a short-circuit section, the speed of the analysis and the computation can be further increased.

It is to be noted that it is possible to compute a frequency characteristic, a current distribution, a magnetic-field distribution and an electric-field distribution by making use of all mesh structures according to the first to seventh embodiments.

In addition, in the first to seventh embodiments, a 3-dimensional insulator section is sandwiched by two 3-dimensional conductor sections. However, possible configurations are not limited to the first to seventh embodiments. That is to say, any configuration is acceptable as long as, in the configuration, the 3-dimensional insulator section is put in a state of being brought into contact with at least one 3-dimensional conductor section.

### LIST OF REFERENCE NUMERALS

1: Analysis computation apparatus
2: Display apparatus
3: Input apparatus
4: Storage apparatus
100: Processing section
101: Matrix-element processing section
102: Tree/co-tree processing section
103: Dependence-condition processing section
104: Solution-substitution/elimination processing section
105: Frequency-characteristic processing section
106: Current-distribution processing section
107: Magnetic-field/electrical-field distribution processing section
108: Display processing section
300, 1200, 1400, 1800 and 2200: Computation system configuration model
301, 1201, 1401a, 1401b, 1501, 1503, 1701, 1703, 1801a to 1801c, 2201a to 2201c, 2401, 1801a, 1801b, 3101a and 3101b: 3-dimensional conductor section (3-dimensional mesh structure section or first mesh structure section)
302, 1202, 1402, 1502, 1702, 1802, 2202, 2402, 1802 and 3102: 3-dimensional insulator section (3-dimensional mesh structure section or first mesh structure section)
303 and 2603: 2-dimensional conductor section (low-dimension mesh structure section or second mesh structure section)
321: Midair conductor section
401, 403, 1301, 1901a, 1901c, 2301a, 2301c, 2701 and 3201: 3-dimensional element
402 and 2702: 2-dimensional element
801 and 801a: First wiring
802 and 802a: Second wiring
803 and 803a: Third wiring
811: Base metal
812 and 812b: Element pad
813: Insulator
821, 1422, 2231b, 1821b and 2412: Ground terminal
822, 1421a, 1421b, 1511, 1512, 1821a, 2231a, 2411 and 2631: Terminal
831 to 833 and 831a to 833a: Wiring connection section
1204, 3103a and 3103b: 1-dimensional conductor section (low-dimension mesh structure section or second mesh structure section)
1302 and 3202: 1-dimensional element
1500, 1700 and 2400: Mesh structure body
1831, 1911, 2001, 2611, 2711, 3121a, 3121b and 3211: Short-circuit section
Z: Analysis computation system

1. An analysis computation method for computing a displacement current of an analysis object by generating a mesh structure comprising elements, comprising the steps of:
an analysis computation apparatus setting a 3-dimensional mesh structure section including 3-dimensional elements and a low-dimension mesh structure section including 2-dimensional or 1-dimensional elements; and
the analysis computation apparatus generating the mesh structure so that the 3-dimensional mesh structure section and the low-dimension mesh structure section are connected to each other.

2. An analysis computation method according to claim 1, wherein the analysis object has a structure in which an insulator is brought into contact with a conductor,
the analysis computation apparatus sets a 3-dimensional insulator section serving as the 3-dimensional mesh structure section in a portion of the insulator,
the analysis computation apparatus sets a 3-dimensional conductor section serving as the 3-dimensional mesh structure in at least a portion among portions of the conductor, the portion being brought into contact with the insulator,
the analysis computation apparatus generates a mesh structure in which a low-dimension conductor section serving as the low-dimension mesh structure section has been set in a portion among the portions of the conductor, the portion being other than the portion in which the 3-dimensional mesh structure section has been set, and
the analysis computation apparatus computes a current and the displacement current of the analysis object by:
using the generated mesh structure to take a time differential of a potential which appears when an AC voltage is applied to the analysis object as an unknown variable and solve a discretized differential equation of the 3-dimensional insulator section, thereby expressing a displacement current solution in terms of a current vector potential, and
using the current vector potential to solve discretized integral equations in the 3-dimensional conductor section and the low-dimension conductor section.

3. An analysis computation method according to claim 1, wherein the low-dimension mesh structure section comprising 2-dimensional elements has a midair configuration expressing an external appearance by the 2-dimensional elements.

4. An analysis computation method for computing a displacement current of an analysis object by generating a mesh structure comprising elements, comprising the steps of:
an analysis computation apparatus setting a first mesh structure section comprising 3-dimensional elements;
the analysis computation apparatus setting a second mesh structure section comprising 3-dimensional, 2-dimensional or 1-dimensional elements;
the analysis computation apparatus generating a mesh structure body in which a short-circuit section with no elements set therein exists between the first mesh structure section and the second mesh structure section; and
upon computation of the mesh structure body, the analysis computation apparatus computing on the assumption that the first mesh structure section and the second mesh structure section have been connected to each other.

5. An analysis computation method according to claim 4, wherein
the analysis object has a structure in which an insulator is brought into contact with a conductor,
the analysis computation apparatus sets a 3-dimensional insulator section serving as the first mesh structure section in a portion of the insulator,
the analysis computation apparatus sets a 3-dimensional conductor section serving as the first mesh structure in at least a portion among portions of the conductor, the portion being brought into contact with the insulator,
the analysis computation apparatus generates a mesh structure in which a second conductor section serving as the second mesh structure section has been set in a portion among the portions of the conductor, the portion being other than the portion in which the 3-dimensional mesh structure section has been set, and
the analysis computation apparatus computes a current and the displacement current of the analysis object by:
using the generated mesh structure to take a time differential of a potential which appears when the displacement current flows to an insulator section of the analysis object when an AC voltage is applied to the analysis object as an unknown variable and solve a discretized differential equation of the 3-dimensional insulator section, thereby expressing a displacement current solution in terms of a current vector potential, and
using the current vector potential to solve discretized integral equations in the 3-dimensional conductor section and the 2-dimension conductor section.

6. An analysis computation method according to claim 4, wherein the second mesh structure section comprising 2-dimensional elements has a midair configuration expressing an external appearance by the 2-dimensional elements.

7. An analysis computation method for computing a displacement current of an analysis object by generating a mesh structure comprising elements, wherein the analysis object has a structure in which an insulator is brought into contact with a conductor, the analysis computation method comprising the steps of:
an analysis computation apparatus setting a 3-dimensional insulator section serving as the mesh structure section in a portion of the insulator;
the analysis computation apparatus generating a mesh structure in which a 3-dimensional conductor section serving as the mesh structure has been set in at least a portion among portions of the conductor, the portion being brought into contact with the insulator; and
the analysis computation apparatus computing a current and the displacement current of the analysis object by:
using the generated mesh structure to take a time differential of a potential which appears when the displacement current flows to an insulator section of the analysis object when an AC voltage is applied to the analysis object as an unknown variable and solve a discretized differential equation of the 3-dimensional insulator section, thereby expressing a displacement current solution in terms of a current vector potential, and
using the current vector potential to solve discretized integral equations in the 3-dimensional conductor section.

8. An analysis computation method according to claim 2, wherein, on the basis of the computed displacement current, the analysis computation apparatus computes a frequency characteristic between an input terminal to which the AC voltage is applied and an output terminal and displays the computed frequency characteristic on a display apparatus.

9. An analysis computation method according to claim 2, wherein, on the basis of the computed displacement current, the analysis computation apparatus computes a current distribution in the mesh structure body with an AC voltage applied to the mesh structure body and displays the computed current distribution on a display apparatus.

10. An analysis computation method according to claim 2, wherein, on the basis of the computed displacement current, the analysis computation apparatus computes a magnetic-field distribution in the mesh structure body with an AC voltage applied to the mesh structure body.

11. An analysis computation method according to claim 2, wherein, on the basis of the computed displacement current, the analysis computation apparatus computes an electric-field distribution in the mesh structure body with an AC voltage applied to the mesh structure body.

12. An analysis computation program to be executed by an analysis computation apparatus to carry out an analysis computation method for computing a displacement current of an analysis object by generating a mesh structure comprising elements, comprising the steps of:
allowing the analysis computation apparatus to set a 3-dimensional mesh structure section including 3-dimensional elements and a low-dimension mesh structure section including 2-dimensional or 1-dimensional elements; and
allowing the analysis computation apparatus to generate the mesh structure so that the 3-dimensional mesh structure section and the low-dimension mesh structure section are connected to each other.

13. An analysis computation program to be executed by an analysis computation apparatus to carry out an analysis computation method for computing a displacement current of an analysis object by generating a mesh structure comprising elements, comprising the steps of:
allowing the analysis computation apparatus to set a first mesh structure section comprising 3-dimensional elements;
allowing the analysis computation apparatus to set a second mesh structure section comprising 3-dimensional, 2-dimensional or 1-dimensional elements;
allowing the analysis computation apparatus to generate a mesh structure body in which a short-circuit section with no elements set therein exists between the first mesh structure section and the second mesh structure section; and
upon computation of the mesh structure, allowing the analysis computation apparatus to compute on the assumption that the first mesh structure section and the second mesh structure section have been connected to each other.

14. An analysis computation program to be executed by an analysis computation apparatus to carry out an analysis computation method for computing a displacement current of an analysis object by generating a mesh structure comprising elements, comprising the steps of:
allowing the analysis object to have a structure in which an insulator is brought into contact with a conductor;
allowing the analysis computation apparatus to set a 3-dimensional insulator section serving as the mesh structure section in a portion of the insulator;
allowing the analysis computation apparatus to generate a mesh structure in which a 3-dimensional conductor section serving as the mesh structure has been set in at least a portion among portions of the conductor, the portion being brought into contact with the insulator; and
allowing the analysis computation apparatus to compute a current and the displacement current of the analysis object by:
using the generated mesh structure to take a time differential of a potential which appears when the displacement current flows to an insulator section of the analysis object when an AC voltage is applied to the analysis object as an unknown variable and solve a discretized differential equation of the 3-dimensional insulator section, thereby expressing a displacement current solution in terms of a current vector potential,
using the current vector potential to solve discretized integral equations in the 3-dimensional conductor section.

15. A recording medium which can be read by a computer and is used for storing an analysis computation program to be executed by an analysis computation apparatus to carry out an analysis computation method for computing a displacement current of an analysis object by generating a mesh structure comprising elements, wherein the analysis computation apparatus is configured to:
set a 3-dimensional mesh structure section comprising 3-dimensional elements and a low-dimension mesh structure section comprising 2-dimensional or 1-dimensional elements; and
generate the mesh structure so that the 3-dimensional mesh structure section and the low-dimension mesh structure section are connected to each other.

16. A recording medium which can be read by a computer and is used for storing an analysis computation program to be executed by an analysis computation apparatus to carry out an analysis computation method for computing a displacement current of an analysis object by generating a mesh structure comprising elements, wherein the analysis computation apparatus is configured to:
set a first mesh structure section comprising 3-dimensional elements;
set a second mesh structure section comprising 3-dimensional, 2-dimensional or 1-dimensional elements;
generate a mesh structure body in which a short-circuit section with no elements set therein exists between the first mesh structure section and the second mesh structure section; and
upon computation of the mesh structure body, compute on the assumption that the first mesh structure section and the second mesh structure section have been connected to each other.

17. A recording medium which can be read by a computer and is used for storing an analysis computation program to be executed by an analysis computation apparatus to carry out an analysis computation method for computing a displacement current of an analysis object by generating a mesh structure comprising elements, wherein
the analysis object has a structure in which an insulator is brought into contact with a conductor,
the analysis computation apparatus is configured to set a 3-dimensional insulator section serving as the mesh structure section in a portion of the insulator,
the analysis computation apparatus is configured to generate a mesh structure in which a 3-dimensional conductor section serving as the mesh structure has been set in at least a portion among portions of the conductor, the portion being brought into contact with the insulator, and
the analysis computation apparatus is configured to compute a current and the displacement current of the analysis object by:
using the generated mesh structure to take a time differential of a potential which appears when the displacement current flows to an insulator section of the analysis object when an AC voltage is applied to the analysis object as an unknown variable and solve a discretized differential equation of the 3-dimensional insulator section, thereby expressing a displacement current solution in terms of a current vector potential, and
using the current vector potential to solve discretized integral equations in the 3-dimensional conductor section.
